(19) United States
(12) Patent Application Publication
(10) Pub. No.: US 2026/0196597 A1
(43) Pub. Date: Jul. 9, 2026

(54) BATTERY PACK AND VEHICLE

(71) Applicant: SEMICONDUCTOR ENERGY LABORATORY CO., LTD., Atsugi-shi, Kanagawa-ken (JP)

(72) Inventors: Takeshi OSADA, Isehara, Kanagawa (JP); Yosuke TSUKAMOTO, Atsugi, Kanagawa (JP); Noboru INOUE, Atsugi, Kanagawa (JP); Kyoichi MUKAO, Odawara, Kanagawa (JP); Haruki KATAGIRI, Atsugi, Kanagawa (JP); Itaru KOYAMA, Atsugi, Kanagawa (JP)

(21) Appl. No.: 18/867,986

(22) PCT Filed: May 12, 2023
(86) PCT No.: PCT/IB2023/054914

§ 371 Date: Nov. 21, 2024

(30) Foreign Application Priority Data
May 27, 2022 (JP) 2022-086696

(51) Int. Cl. H01M 10/6554; B60L 50/64; H01M 10/613; H01M 10/625; H01M 10/647; H01M 10/658; H01M 50/209; H01M 50/211; H01M 50/249

(52) U.S. Cl. CPC H01M 10/6554; H01M 10/613; H01M 10/625; H01M 10/647; H01M 10/658; H01M 50/209; H01M 50/211; H01M 50/249; B60L 50/64; H01M 2220/20

(57) ABSTRACT

A battery pack with reduced cost is provided. The battery pack includes a plurality of battery cells, a heat dissipation mechanism, and a switching mechanism. The switching mechanism moves the heat dissipation mechanism in accordance with the temperature of the plurality of battery cells to switch a state where the battery cell and the heat dissipation mechanism are close to each other and a state where the battery cell and the heat dissipation mechanism are separated from each other. The heat dissipation mechanism preferably includes a heat sink utilizing natural cooling. Furthermore, a heat transfer plate is preferably included.

### TECHNICAL FIELD

One embodiment of the present invention relates to a battery pack and a vehicle equipped with a battery pack.

One embodiment of the present invention is not limited to the above technical field, and a battery pack can be equipped in a power storage device, for example. Note that the power storage device has a function of storing electric power obtained from power generation facilities such as a solar power generation panel.

One embodiment of the present invention is not limited to the above technical field, and relates to a semiconductor device, a display device, a light-emitting device, a recording device, a driving method thereof, or a manufacturing method thereof. That is, the technical field of one embodiment of the invention disclosed in this specification and the like relates to an object, a method, or a manufacturing method.

### BACKGROUND ART

High-voltage secondary batteries are equipped in vehicles such as electric vehicles. Since temperatures at which secondary batteries can be charged and discharged efficiently are lower than temperatures acceptable to other devices equipped in vehicles, secondary batteries are often equipped separately from other devices in vehicles, that is, equipped in the state of being held in cases in vehicles. Secondary batteries and the like held in a case are referred to as a battery pack. In order to provide sufficient power for a vehicle, battery modules in which assembled batteries are stored in housings are spread in a battery pack, which causes an extremely heavy weight of the battery pack. An effective space for installing such a battery pack is under the floor of a vehicle.

A battery pack provided under the floor is easily affected by temperatures of the outside (outside temperature); thus, research and development on a temperature control mechanism is actively conducted. In Patent Document 1, heat generated in a battery cell is released using a heat transfer plate, so that a heat dissipation property of the battery cell is ensured.

When a vehicle is charged, it is desired for a secondary battery to control the temperatures to prevent excessive heating or cooling down. Patent Document 2 discloses a temperature control mechanism provided in a battery module. The temperature control mechanism is configured to switch a non-heat transfer state in which an assembled battery is separated from a cooling portion of the battery module and a heat transfer state in which the assembled battery is close to the cooling portion are switched using a bimetal.

### REFERENCES

### Patent Documents

[Patent Document 1] Japanese Published Patent Application No. 2018-041583
[Patent Document 2] Japanese Published Patent Application No. 2019-160442

### SUMMARY OF THE INVENTION

### Problems to be Solved by the Invention

When the heat transfer plate is fixed as in Patent Document 1, heat is excessively released in accordance with outside temperatures. In addition, the temperature control mechanism of Patent Document 2 has a high cost. In view of the above, an object of the present invention is to provide a battery pack with a simple structure and further reduced in cost, a vehicle equipped with the battery pack, and the like.

Note that the description of these objects does not preclude the existence of other objects. Note that one embodiment of the present invention does not need to achieve all the objects. Note that other objects can be derived from the description of the specification, the drawings, and the claims (referred to as the specification and the like).

### Means for Solving the Problems

Considering the above description, one embodiment of the present invention is a battery pack including a plurality of battery cells, a heat dissipation mechanism, and a switching mechanism. The switching mechanism moves the heat dissipation mechanism in accordance with the temperature of the plurality of battery cells to switch a state where the battery cells and the heat dissipation mechanism are close to each other and a state where the battery cells and the heat dissipation mechanism are separated from each other. The plurality of battery cells are referred to as a cell block in some cases.

Another embodiment of the present invention is a battery pack including a plurality of battery cells, a heat dissipation mechanism, a switching mechanism, and a heat transfer plate. One end of the heat transfer plate includes a first region in contact with the plurality of battery cells. The other end of the heat transfer plate includes a second region overlapping with the heat dissipation mechanism. The switching mechanism is configured to move the second region in accordance with the temperature of the plurality of battery cells to switch a state where a battery module and the heat dissipation mechanism are close to each other and a state where the battery module and the heat dissipation mechanism are separated from each other.

In another embodiment of the present invention, the heat dissipation mechanism preferably include a region not overlapping with the plurality of battery cells and the switching mechanism is preferably placed in the region in a top view.

In another embodiment of the present invention, the switching mechanism preferably includes a bimetal member.

In another embodiment of the present invention, a housing including a heat-insulating member surrounding the plurality of battery cells is preferably included.

In another embodiment of the present invention, the heat dissipation mechanism preferably includes a heat sink, further preferably include a heat sink utilizing natural cooling.

Another embodiment of the present invention is a vehicle equipped with a battery pack.

### Effect of the Invention

With a battery control system of one embodiment of the present invention, a battery pack that enables a secondary battery to be charged and discharged efficiently and has low cost can be provided.

Note that the description of these effects does not preclude the existence of other effects. Note that one embodiment of the present invention does not need to have all the effects. Note that other effects will be apparent from the description of the specification, the drawings, the claims, and the like, and other effects can be derived from the description of the specification, the drawings, the claims, and the like.

### BRIEF DESCRIPTION OF THE DRAWINGS

FIG. 1A is a diagram illustrating a vehicle of one embodiment of the present invention, and FIG. 1B and FIG. 1C are diagrams illustrating a battery pack of one embodiment of the present invention.

FIG. 2 is a diagram illustrating a battery module of one embodiment of the present invention.

FIG. 3A and FIG. 3B are diagrams illustrating a battery module of one embodiment of the present invention.

FIG. 4A and FIG. 4B are diagrams illustrating a battery module of one embodiment of the present invention.

FIG. 5 is a diagram illustrating a battery module of one embodiment of the present invention.

FIG. 6 is a diagram illustrating a battery module of one embodiment of the present invention.

FIG. 7 is a diagram illustrating a battery module of one embodiment of the present invention.

FIG. 8 is a diagram illustrating a battery module of one embodiment of the present invention.

FIG. 9A and FIG. 9B are diagrams illustrating a battery module of one embodiment of the present invention.

FIG. 10A is a diagram illustrating a battery pack of one embodiment of the present invention, and FIG. 10B is a diagram illustrating a cell block.

FIG. 11A and FIG. 11B are diagrams illustrating a battery module of one embodiment of the present invention.

FIG. 12 is a diagram illustrating a battery module of one embodiment of the present invention.

FIG. 13 is a diagram illustrating a battery module of one embodiment of the present invention.

FIG. 14 is a diagram illustrating a battery module of one embodiment of the present invention.

FIG. 15A and FIG. 15B are diagrams illustrating a positive electrode that is one embodiment of the present invention.

FIG. 16A and FIG. 16B are diagrams illustrating a laminated cell of one embodiment of the present invention.

FIG. 17A and FIG. 17B are diagrams illustrating a method for manufacturing a laminated cell of one embodiment of the present invention.

FIG. 18A to FIG. 18C are diagrams illustrating a battery cell of one embodiment of the present invention.

FIG. 19A to FIG. 19C are diagrams illustrating a battery cell of one embodiment of the present invention.

FIG. 20A to FIG. 20C are diagrams illustrating vehicles of one embodiment of the present invention.

FIG. 21A and FIG. 21B are diagrams illustrating power storage devices of one embodiment of the present invention.

### MODE FOR CARRYING OUT THE INVENTION

Embodiment examples for carrying out the present invention will be described below with reference to the drawings and the like. Note that the present invention should not be interpreted as being limited to the embodiment examples given below. Embodiments for carrying out the invention can be changed unless they deviate from the spirit of the present invention.

### Embodiment 1

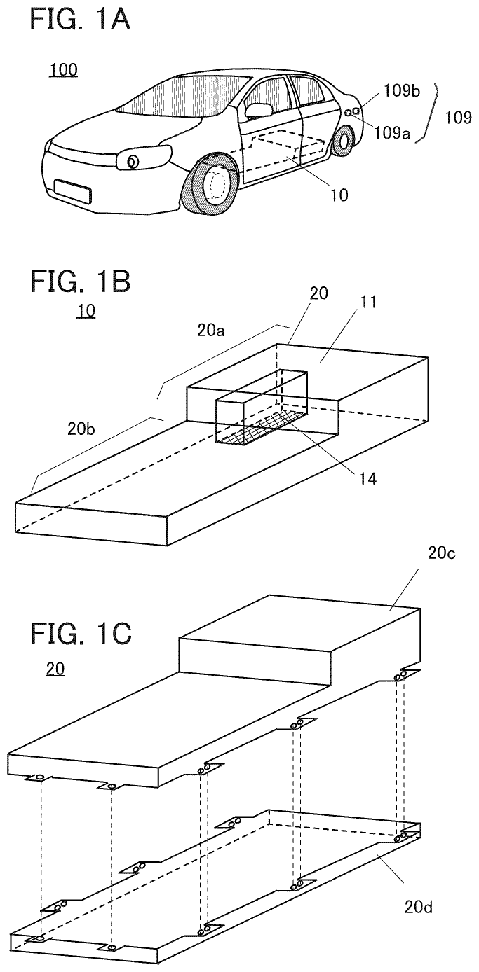

In this embodiment, a vehicle and a battery pack of one embodiment of the present invention are described with reference to FIG. 1 to FIG. 14, and the like. Note that the battery pack of one embodiment of the present invention can be equipped in a power storage device, and thus the invention can be understood by replacing a vehicle in this embodiment and the like with a power storage device.

### Structure Example 1

As illustrated in FIG. 1A, a vehicle 100 of one embodiment of the present invention includes a battery pack 10 provided under the floor, a charging port 109, and the like. The number of charging ports 109 provided is preferably two; one of them is preferably used as a charging port 109a for normal charging and the other is preferably used as a charging port 109b for rapid charging.

As illustrated in FIG. 1B, the battery pack 10 of one embodiment of the present invention includes a battery module 11 held in a case 20. As illustrated in FIG. 1C, the case 20 is a combination of an upper portion 20c and a lower portion 20d and can be regarded as an outer box. The battery module 11 held in the case 20 can prevent entry of water. The battery module 11 is placed in the lower portion 20d. Although not illustrated, a guide is preferably provided on the lower portion 20d so that the battery module 11 can be easily positioned. The lower portion 20d of the case is fixed to the upper portion 20c of the case. For example, the protruding portion of the upper portion 20c and the protruding portion of the lower portion 20d overlap with each other along the dashed line illustrated in FIG. 1C, and can be fixed by using a volt or the like. The battery module 11 is desired to be fixed strongly because it is affected by the vibration of the vehicle 100 in some cases. In view of this, a frame-like support may be provided along the battery module 11. The frame-like support is referred to as a support. It is preferable that part of the support be placed to overlap with the upper side and the horizontal side of the battery module 11 and the other part of the support be fixed to the lower portion 20d.

The case 20 can have any shapes, and FIG. 1B illustrates the case 20 including a first portion 20a and a second portion 20b as an example. Although a plurality of battery modules 11 are provided in the case 20, FIG. 1B illustrates an example in which the battery module 11 is positioned in the first portion 20a. The first portion 20a includes a region whose length of the case 20 in the vertical direction is larger than that in the second portion 20b, and is positioned at a portion mainly overlapping with the rear seat of the vehicle 100. Since the volume of the first portion 20a is large, the battery modules 11 can be stacked. Since the first portion 20a has a large vertical height in the case 20, the battery module 11 can be placed vertically. The vertical direction includes a direction in which a wide surface of the battery module 11 is perpendicular to the lower portion 20d. In the second portion 20b, the battery module 11 can be placed horizontally, and thus the orientation of overlapping with the battery modules 11 to each other can be different from that in the first portion 20a. The horizontal direction includes a direction in which a narrow surface of the battery module is perpendicular to the lower portion 20d. Although not illustrated, a third portion may be provided in a portion overlapping with the front seat of the vehicle 100. The third portion can have a shape similar to that of the first portion 20a. That is, in the third portion, the battery module 11 can be placed vertically. The shape of the case 20 is preferably changed appropriately depending on the number of battery modules 11.

The plurality of battery modules are preferably held in the case 20 while being adjacent to each other. Since the battery modules are adjacent to each other, a variation in temperatures can be reduced. The temperature can be checked with a temperature sensor provided in the battery pack 10. For this reason, a plurality of temperature sensors are preferably provided in the battery pack 10. Since the support portion for fixing the battery module 11 has a frame-like shape, the temperatures of the adjacent battery modules can be further close to one another.

In order to reduce a temperature variation of the battery modules, a heat-insulating member may be used for the case 20. The use of the heat-insulating member for the case 20 can reduce the influence of the outside temperature. For example, when the heat-insulating member is used for the bottom surface or for the bottom and a side surface of the case 20, the temperature variation between the battery modules can be further reduced. It is also effective to additionally place a heat-insulating member on the outer side of the bottom surface or on the outer sides of the bottom surface and the side surface of the case 20.

Although FIG. 1B illustrates the battery module 11 including a heat dissipation mechanism 14, the heat dissipation mechanism 14 can be independent of the battery module 11; for example, the heat dissipation mechanism 14 can be placed outside the case 20. In the case where a temperature of the heat dissipation mechanism 14 is equal to the outside temperature, that is, a state where the temperature is changed in accordance with the outside temperature is desired, it is effective to place the heat dissipation mechanism 14 outside the case 20. The temperature of the heat dissipation mechanism 14 can be checked with a temperature sensor installed in the battery pack 10.

Although FIG. 1B illustrates a mode in which the heat dissipation mechanism 14 is positioned on a bottom surface of the battery module 11, the heat dissipation mechanism 14 may be positioned on a top surface or a side surface of the battery module 11. In the case where the battery module 11 has a rectangular solid (a rectangular-box shape), the heat dissipation mechanism 14 is not necessarily placed on the bottom surface. In order to make the heat dissipation mechanism 14 function efficiently, the dissipation mechanism 14 is placed on a surface having the largest area of the battery module 11. Specifically, in the case where the battery module 11 has a first surface and a second surface larger than the first surface, the heat dissipation mechanism 14 is preferably placed to face the second surface. Any arrangement is possible as long as the heat dissipation mechanism 14 can be placed such that heat radiation is effective.

Note that although the heat dissipation mechanism 14 releases heat from the battery module 11, heat is efficiently released by using a region not overlapping with the battery module 11. Therefore, the heat dissipation mechanism 14 is preferably formed to include a region not overlapping with the battery module 11. In view of this, it is preferable that the heat dissipation mechanism 14 be placed to face the surface having the largest area of the battery module 11, and include a region protruding from the battery module 11 and not overlapping with the battery module 11.

Although FIG. 1B shows an example of providing one battery module 11 with respect to one heat dissipation mechanism 14, a plurality of battery modules may share one heat dissipation mechanism 14. To speak of extremes, all the battery modules held in the case 20 can share one heat dissipation mechanism 14. In practice, it is preferable that a set of battery modules be determined and that one heat dissipation mechanism 14 be placed for the set. According to such arrangement, the number of members related to the heat dissipation mechanism 14 is reduced, whereby the cost can be reduced.

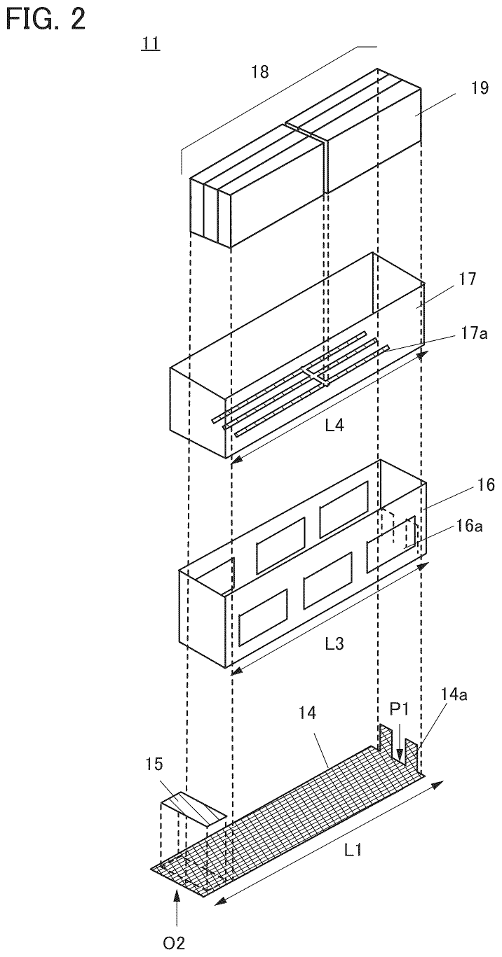

Next, FIG. 2 illustrates an example of the structure of the battery module 11. The battery module 11 includes the heat dissipation mechanism 14, a switching mechanism 15, a first housing 16, a second housing 17, and a cell block 18. As described above, the heat dissipation mechanism 14 can be independent of the battery module 11. Similarly, the switching mechanism 15 can also be independent of the battery module 11.

### Cell Block

The cell block 18 includes a plurality of battery cells 19, and a rectangular battery cell, a laminated battery cell, or the like can be used as the battery cell 19. In this specification and the like, a battery cell means a single battery. In the case where a laminated battery cell is used, the battery cell 19 can have a structure where a plurality of laminated battery cells are stacked. Among a plurality of battery cells 19, two or more sets in each of which laminated battery cells are electrically connected in parallel are prepared, and the sets are electrically connected in series. The cell block 18 refers to a group including the above-described sets. A composition in which a plurality of battery cells are electrically connected to each other is referred to as an assembled battery in some cases. FIG. 2 illustrates the cell block 18 including six battery cells; specifically, two sets in which three battery cells are electrically connected in parallel can be prepared and connected in series. Note that the number of the battery cells described above can be replaced with a given number.

### Heat Dissipation Mechanism

The heat dissipation mechanism 14 only needs to release heat of the battery cell 19 or the like; for example, a heat sink or the like can be used. A heat sink has a function of releasing absorbed heat into the air, and examples of heat sink include a heat sink utilizing natural cooling and a heat sink utilizing forced cooling. A heat sink utilizing natural cooling has a heat radiator plate, a cooling plate, or the like. A heat sink utilizing natural cooling is suitable because of its low energy consumption. In the case of utilizing natural cooling, a surface area of the heat sink is preferably increased in order to perform cooling efficiently. For example, projections and depressions are formed in part or the whole of the heat sink, whereby the surface area can be increased. Such a heat sink is referred to as a heat sink having a fin structure, where the projections and depressions described above are referred to as a fin structure in some cases. In the case of utilizing forced cooling, heat can be efficiently released by providing a tube inside the heat dissipation mechanism 14 or the like and supplying a liquid or a gas to the tube. The tube is also referred to as a heat pipe.

Although the size of the heat dissipation mechanism 14 illustrated in FIG. 2 is larger than the area of the bottom surface of the cell block 18, this is just an example. The heat dissipation mechanism 14 can include a region not overlapping with the cell block 18, which can increase the heat radiation efficiency. Note that the heat dissipation mechanism 14 can have any size as long as heat of the cell block 18, specifically, heat from the battery cell 19 can be released. Furthermore, the heat dissipation mechanism 14 may be divided into two or more parts. In the case where the heat dissipation mechanism 14 is divided, two or more switching mechanisms described later are preferably provided.

Although the heat dissipation mechanism 14 illustrated in FIG. 2 is placed below the battery module 11, this is just an example; the heat dissipation mechanism 14 may be placed on the side surface side of the battery module 11 or above the battery module 11. The heat dissipation mechanism 14 positioned below the battery module 11 is preferable because heat is easily released into the air. In the case where the heat dissipation mechanism 14 is placed below the battery module 11, the heat dissipation mechanism 14 is preferably fixed to any of housings described later. The heat dissipation mechanism 14 may include a protruding portion 14a as a fixed region. The protruding portion 14a may be selectively provided. The protruding portion 14a may be formed using a member different from that of the heat dissipation mechanism 14. In the case where the heat dissipation mechanism 14 is moved (is operated, or is activated), a housing and the heat dissipation mechanism 14 may be fixed to each other by using a component such as a hinge instead of or with the protruding portion 14a.

### Switching Mechanism

The relative positions between the cell block 18 and the heat dissipation mechanism 14 are preferably switched by using the switching mechanism 15. Specifically, by the switching mechanism 15, a state A where the cell block 18 and the heat dissipation mechanism 14 are close to each other and a state B where the cell block 18 and the heat dissipation mechanism 14 are separated from each other may be changed from one another. Since the relative positions may be switched, the cell block 18 may be moved or the cell block 18 and the heat dissipation mechanism 14 may be moved.

The state where the cell block and the heat dissipation mechanism are close to each other (the close state) includes a state where the cell block 18 and the heat dissipation mechanism 14 are in contact with each other. In addition, a state where a heat transfer plate that can be regarded as having the temperature equal to that of the cell block 18 and the heat dissipation mechanism 14 are in contact with each other is also included. In addition, a state in which a heat transfer plate that can be regarded as having the temperature equal to that of the heat dissipation mechanism 14 and the cell block 18 are in contact with each other is also included. Furthermore, in the case where the switching mechanism 15 has contacts, a state where the contacts are in contact with each other is also included in the close state. Note that as described later, the term “close state” may be used as long as heat of the cell block 18 can be released through the heat dissipation mechanism 14.

### Close State

The state where the cell block and the heat dissipation mechanism are close to each other will be described in detail. In the case where a heat sink utilizing natural cooling is used as the heat dissipation mechanism 14, in the close state A, heat of the cell block 18 can be released through the heat dissipation mechanism 14 when the temperature of the cell block 18 increases due to charging and discharging, specifically, when the temperature becomes higher than the outside temperature. In the close state A, the temperature of the cell block 18 is controlled to be equal to or substantially equal to the temperature of the heat dissipation mechanism 14. Thus, the temperature of the heat dissipation mechanism 14 is preferably set to an appropriate temperature for charging and discharging. Furthermore, since the heat dissipation mechanism 14 follows the outside temperature, the outside temperature is preferably set to an appropriate temperature for charging and discharging.

In the case where the heat sink utilizing forced cooling is used as the heat dissipation mechanism 14, a release of heat can be considered separately from the outside temperature in the close state A; specifically, the heat of the cell block 18 can be released through the heat dissipation mechanism 14 when the temperature of the cell block 18 increases due to charging and discharging. This is because the temperature of the heat dissipation mechanism 14 can be controlled regardless of the outside temperature.

### Temperature Suitable for Charging and Discharging

The temperature suitable for charging and discharging can be determined by the battery characteristics of the battery cell 19; in the case where the battery pack 10 is equipped in the vehicle 100, the temperature is preferably higher than or equal to 15° C. and lower than 40° C., further preferably higher than or equal to 20° C. and lower than or equal to 35° C., still further preferably higher than or equal to 20° C. and lower than or equal to 30° C. In the case where the battery pack 10 is equipped in the vehicle 100, the temperature suitable for charging and discharging is 35° C.±10° C., preferably 35° C.±5° C., further preferably 35° C.±2° C., still further preferably 35° C.±1° C. Whether the temperature is suitable for charging and discharging can be checked with a temperature sensor provided in the battery pack 10.

The temperature that is not suitable for charging and discharging is a temperature below freezing, for example. When the temperature of the battery cell 19 measured with the temperature sensor is 0° C. or the like, the efficiency of charging and discharging is extremely lowered, for example. Thus, when the temperature exceeds the lower limit of the temperature suitable for charging and discharging and changes to a temperature that is not suitable for charging and discharging, the cell block 18 can be independent of the heat dissipation mechanism by using the switching mechanism 15. When the lower limit of the temperature suitable for charging and discharging is 15° C., it takes time to decrease from 15° C. to 0° C. Thus, the switching speed by the switching mechanism 15 is not highly required.

### Separated State

Even in the case where the heat sink utilizing natural cooling is used as the heat dissipation mechanism 14 or in the case where the heat sink utilizing forced cooling is used as the heat dissipation mechanism 14, the cell block 18 is cooled too much by the heat dissipation mechanism 14 in some cases. This is referred to as overcooling or overradiation. For example, the state where the temperature of the cell block 18 becomes lower than 15° C. is referred to as overcooling. In that case, the state is brought into the separated state B to prevent the overcooling. In a simple description, the separated state is a state where the cell block 18 and the heat dissipation mechanism 14 are separated from each other, and specifically, the distance between the position of the cell block 18 and the position of the heat dissipation mechanism 14 is larger than that in the above-described state A. When the positions are separated from each other, the temperature of the cell block 18 and the temperature of the heat dissipation mechanism 14 are independent of each other, and the temperature of the cell block 18 is controlled to be different from that of the heat dissipation mechanism 14. Thus, as long as the temperatures are independent as described above, even when a state where part of the heat dissipation mechanism 14 approaches the cell block 18 is observed, the state is included in the separated state.

The heat dissipation mechanism 14 using a heat sink utilizing natural cooling has the temperature equal to or substantially equal to the outside temperature. For example, when the outside temperature is below freezing and the temperature below freezing is not suitable for charging and discharging, the cell block 18 can be independent of the temperature of the heat dissipation mechanism 14 by being brought into the state B. In such a state, the cell block 18 can be heated by utilizing charging or the like. That is, even when the outside temperature is below freezing, the temperature of the cell block 18 does not become below freezing and can be set to the temperature suitable for charging and discharging by being brought into the state B. Furthermore, a heater may be placed as a means for heating the cell block 18. A PTC (Positive Temperature Coefficient) heater or the like can be used as the above heater. As a means of heating the cell block 18, air inside the vehicle 100 may be supplied to the cell block 18, whereby the cell block 18 is heated. In order to supply air in the room, a duct may be placed in the case 20, or a blower, a fan, or an air blower connected to the duct may be provided.

In order to achieve switching the state A and the state B, the switching mechanism 15 has a switching function in accordance with temperatures. For example, a thermostat can be used for the switching mechanism 15. Furthermore, the switching mechanism 15 preferably has a function of moving a member; by using a bimetallic thermostat (hereinafter referred to as a bimetal switch) or a ferrite switch as the thermostats, an operation mechanism can be provided, and the thermostat may be combined with pins or the like to have the operation mechanism.

### Bimetal Switch

A bimetal switch includes a bimetal member, and can perform opening and closing contacts by utilizing thermal expansion of a metal that is the bimetal member. The force of a spring may be utilized to increase the speed of opening and closing the contacts. Among the bimetal members, an alloy including iron or nickel is preferably used as a metal having a high thermal expansion, and chromium, manganese, or magnesium is preferably further included as an additive element. Among the bimetal members, an alloy of iron and nickel can be used as a metal having a low thermal expansion. Such a bimetal switch is preferable because of its low cost and high durability.

### Ferrite Switch

A ferrite switch includes a ferrite member and performs opening and closing of contacts by utilizing appearance or disappearance of magnet properties with the curie temperature as a boundary. In other words, the ferrite member or the like switch between a ferromagnetic body and a paramagnetic body with the curie point as the boundary, and performs opening and closing of the contacts by utilizing this property. The appearance and disappearance of magnet properties are derived from change of the crystal structure due to temperature rise, and the change is referred to as a phase transition phenomenon of a substance. Among the ferrite members, a material which can rapidly change the property of a magnetic body with the curie temperature as the boundary is referred to as a temperature-sensitive ferrite member, and the temperature-sensitive ferrite member is suitable for the switching mechanism 15.

As another example, a temperature-sensitive lead switch that utilizes a difference between the curie temperature of the permanent magnet and the curie temperature of the temperature-sensitive ferrite is preferably used for the switching mechanism 15, and this is included in the ferrite switch. Examples of the temperature-sensitive lead switch includes a switch that closes the contacts with temperature rise and a switch that opens the contacts with temperature rise; either structure may be employed for the switching mechanism 15.

The above-described ferrite switch is preferable because it has a smaller variation in on/off temperatures than the bimetal switch.

As illustrated in FIG. 2, the switching mechanism 15 is preferably placed in the vicinity of the heat dissipation mechanism 14 whose movement is controlled, and is preferably placed in a region where the heat dissipation mechanism 14 is not overlap with the cell block 18 in a top view. The region is a region where heat radiation is efficiently performed and it is preferable that the region be separated initiatively from the cell block 18 in the state B; thus, the switching mechanism 15 is preferably placed so as to overlap with the region.

The shape and size of the switching mechanism 15 are just an example, and the switching mechanism 15 can have any shape and size as long as the switching mechanism 15 can be positioned as described above. Since the above-described bimetal switch, magnet switch, and ferrite switch are small components, the switching mechanism 15 can be small, which is preferable. The shape of a bimetal switch is circular in many cases in the top view.

### Movement of Heat Dissipation Mechanism

Movement of the heat dissipation mechanism 14 is preferably controlled by the switching mechanism 15. In other words, the heat dissipation mechanism 14 preferably includes a movable portion that is moved by the switching mechanism 15. Specifically, in the heat dissipation mechanism 14, a side including a point P1 and the vicinity thereof are used as a fulcrum and a side including a point O2 facing the side are preferably moved up and down. Thus, as illustrated in FIG. 2, the switching mechanism 15 is preferably placed in the vicinity of the side including the point O2.

For example, in the case where a bimetal switch is used as the switching mechanism 15, the state of the bimetal member is changed by thermal expansion, and the side including the point O2 and the vicinity thereof of the heat dissipation mechanism 14 and the vicinity thereof can be moved up and down according to the change in the state. By operating the position of the side including the point O2 in the heat dissipation mechanism 14 up and down, the above state A and state B can be switched.

Furthermore, part of the bimetal member is preferably in contact with the battery cell 19 or the like. Alternatively, a heat transfer plate or the like that enables heat transfer between the bimetal member and the battery cell 19 is preferably interposed therebetween. With such a structure, the thermal expansion of the bimetal member can be happened in accordance with the temperature of the battery cell 19, so that the state A and the state B can be switched according to the temperature of the battery cell 19.

### Usage Example 1 of Bimetal Switch

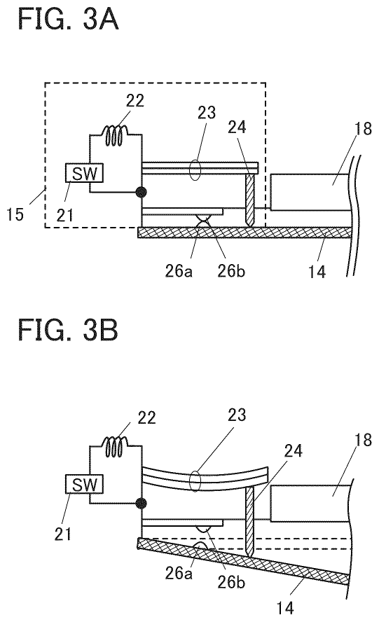

The switching mechanism 15 using a bimetal switch is described with reference to FIG. 3A and FIG. 3B. The bimetal switch is positioned to overlap with the heat dissipation mechanism 14 and to be in the vicinity of the side O2. At this time, the bimetal switch preferably does not overlap with the cell block 18. The switching mechanism 15 such as the bimetal switch is preferably fixed by using a housing described later.

Although not illustrated, part of the cell block 18, specifically, a side surface of the cell block 18 is preferably surrounded with a heat-insulating member or the like. The heat dissipation mechanism 14 can make it easy to control the temperature of the cell block 18. In order to surround the part of the cell block 18 with the heat-insulating member, the cell block 18 may be provided for a housing including the heat-insulating member. The heat-insulating member may have a sheet-like shape and be attached to the cell block 18.

The switching mechanism 15 using the bimetal switch includes a switch 21, a heater 22, a bimetal member 23, and a pin 24 and has a function of controlling opening and closing of contacts: a first contact 26a and a second contact 26b. The first contact 26a is preferably placed to be in contact with the heat dissipation mechanism 14. The second contact 26b is preferably placed to be in contact with the cell block 18, and at least a member whose temperature is equal to the temperature of the cell block 18 is preferably used. A PTC heater or the like is preferably used as the heater 22. The heater 22 may be placed so as to be electrically connected to the cell block 18. The temperature of the cell block 18 can also be controlled by utilizing the heat of the heater 22. The first contact 26a is electrically connected to the heat dissipation mechanism 14, and the second contact 26b is electrically connected to the cell block 18.

FIG. 3A illustrates a state where the cell block 18 and the heat dissipation mechanism 14 are closely placed so that the temperature of the cell block 18 is equal to or substantially equal to the temperature of the heat dissipation mechanism 14, and the first contact 26a is in contact with the second contact 26b. The state in FIG. 3A corresponds to the above state A. In other words, it can be said that the temperature of the cell block 18 is controlled to be equal to or substantially equal to the temperature of the heat dissipation mechanism 14. Note that in the close state, the cell block 18 and the heat dissipation mechanism 14 are not necessarily in contact with each other as long as the above temperature can be controlled. The temperature of the heat dissipation mechanism 14 in accordance with the temperature of the outside temperature is the upper limit temperature of the cell block 18 in the state in FIG. 3A; when the temperature of the cell block 18 is increased by charging and discharging, heat of the cell block 18 is released through the heat dissipation mechanism 14.

In the switching mechanism 15 in FIG. 3A, the switch 21 is in an off state and the heater 22 is not heated. The bimetal member 23 connected to the heater 22 is in a first state and forms a linear state as illustrated in FIG. 3A, for example. Instead of a linear state, a curved state may be employed. The pin 24 in contact with the bimetal member 23 is positioned in accordance with the bimetal member 23, and the pin 24 is in contact with the heat dissipation mechanism 14 to the extent where the position of the heat dissipation mechanism 14 is not changed. Needless to say, the pin 24 may be separated from the heat dissipation mechanism 14. Since the cell block 18 and the heat dissipation mechanism 14 are kept close to each other as described above, the temperature of the cell block 18 is kept within a temperature range suitable for charging and discharging with the temperature of the heat dissipation mechanism 14 as the upper limit. In other words, the temperature of the cell block 18 never increases to the temperature that is not suitable for charging and discharging by heat radiation with the heat dissipation mechanism.

FIG. 3B illustrates an overcooling state, that is, a state where the temperature of the cell block 18 is lower than the temperature suitable for charging and discharging. The state in FIG. 3B corresponds to the above state B. Since the temperature of the heat dissipation mechanism 14 changes in accordance with the outside temperature, the temperature of the heat dissipation mechanism 14 decreases following the outside temperature when the outside temperature is below freezing, for example, and is approximately below freezing. When the state of FIG. 3A is maintained in such a situation, the temperature of the cell block 18 may also be below freezing.

Thus, the switch 21 is turned on when the temperature of the cell block 18 is detected as the temperature reaching an unsuitable temperature, such as temperature below freezing. When the switch 21 is turned on, the heater 22 is heated. The bimetal member 23 connected to the heated heater 22 is turned into a second state different from the first state, e.g., a concave state as illustrated in FIG. 3B. Note that when the switch 21 is turned on, the cell block 18 may be heated by the heater 22.

The pin 24 is pushed down in accordance with the bimetal member 23, and at least the first contact 26a is separated from the second contact 26b. In FIG. 3B, the position of the heat dissipation mechanism 14 in FIG. 3A is denoted by a dashed line, and the heat dissipation mechanism 14 is also pushed down in accordance with the position of the pin 24. The above contacts are separated from each other, and the distance between the heat dissipation mechanism 14 and the cell block 18 can be larger than that in FIG. 3A. In FIG. 3B, the maximum distance between the heat dissipation mechanism 14 and the cell block 18 is greater than or equal to 1 cm, preferably greater than or equal to 3 cm. In other words, the level of the top surface of the heat dissipation mechanism 14 in FIG. 3B is lower than that in FIG. 3A by 1 cm or more, preferably, by 3 cm or more.

The state in FIG. 3B is referred to as a state where the cell block 18 and the heat dissipation mechanism 14 are separated from each other, and the temperatures of them are independent of each other. In the separated state, overcooling can be prevented. As long as the overcooling is prevented, the separated state may include a state where the heat dissipation mechanism 14 partly approaches the cell block 18. The position of part of the heat dissipation mechanism 14 and the position of part of the cell block 18 are not necessarily changed from those in FIG. 3A, while they are in accordance with the position of the pin 24.

After the temperatures of the cell block 18 and the heat dissipation mechanism 14 increase to the temperature suitable for charging and discharging, the state in FIG. 3B is changed to the state in FIG. 3A. As described above, the state in FIG. 3A and the state FIG. 3B can be switched by using the switching mechanism 15 in accordance with the temperature of the cell block 18 or the like.

### Usage Example 2 of Bimetal Switch

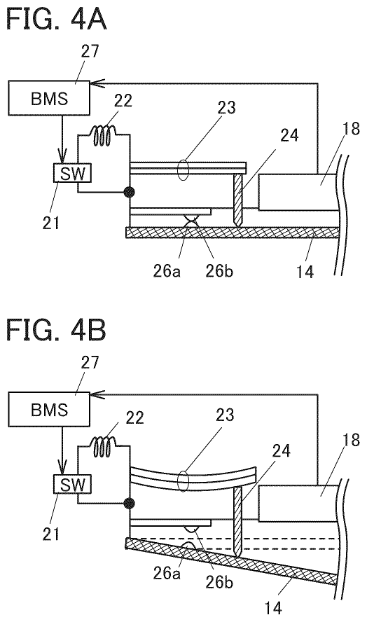

Another mode of the switching mechanism 15 using a bimetal switch is described with reference to FIG. 4A and FIG. 4B.

In FIG. 4A and FIG. 4B, a temperature sensor is provided in the cell block 18, and the temperature of the cell block 18 is managed by a battery management system 27 (denoted as BMS hereinafter and in the drawing). Since the BMS can output a signal for controlling the switch 21, the switch 21 can be in an off state in FIG. 4A and the switch 21 can be turned on in FIG. 4B. The other structures can be similar to those in FIG. 3A and FIG. 3B described above. Note that BMS is a system that controls safety; in addition to the information about the temperature of the battery cell 19, deterioration information can also be managed.

Although not described in FIG. 3A to FIG. 4B, the switching mechanism 15 may move the cell block 18 instead of the heat dissipation mechanism 14. Furthermore, the switching mechanism 15 may move both the heat dissipation mechanism 14 and the cell block 18. That is, overcooling can be prevented by increasing the distance between the heat dissipation mechanism 14 and the cell block 18.

### Housing

The first housing 16 and the second housing 17 illustrated in FIG. 2 are described. It is preferable that the first housing 16 be positioned outward from the second housing 17 and the second housing 17 be positioned inward from the first housing 16. Thus, a length L3 of the side of the first housing 16 is preferably longer than a length L4 of the side of the second housing 17. The above description of the lengths L3 and L4 are a description about the long sides, and the same applies to the short sides of the first housing 16 and the second housing 17. The first housing 16 is preferably formed using a metal material, specifically, aluminum, nickel, or the like, and the second housing 17 is preferably formed using an organic material, specifically, a resin material, or the like. A metal material has high strength and thus is used for an outer housing, and a resin material has softness and thus is used for an inner housing. Note that only one of the first housing 16 and the second housing 17 may be provided.

In the first housing 16, an opening portion is preferably provided in a surface facing the heat dissipation mechanism 14, i.e., the bottom surface. It is preferable that the whole or part of the cell block 18 be exposed from the first housing 16. Furthermore, also in the second housing 17, an opening portion may be provided in a surface facing the heat dissipation mechanism 14, i.e., the bottom surface, so as to expose the cell block 18. It is preferable that the whole or part of the cell block 18 be exposed from the first housing 16 and the second housing 17. In order to reduce the weight of the first housing 16, an opening portion 16a like a window may be provided. Similarly, the second housing 17 may have an opening portion like a window; however, it is not illustrated in FIG. 2.

On the bottom surface of the second housing 17, a guide 17a for fixing the cell block 18 is preferably provided. The use of the guide 17a facilitates positioning of the battery cell 19. In the case where part of the cell block 18 is exposed from the bottom surface of the second housing 17, the guide 17a is formed in a lattice shape.

Furthermore, the second housing 17 may be provided with an opening portion through which at least the side including the point O2 of the heat dissipation mechanism 14 is moved up and down. Furthermore, the first housing 16 may be provided with an opening portion through which at least the side including the point O2 of the heat dissipation mechanism 14 is moved up and down.

The above-described protruding portion 14a of the heat dissipation mechanism is preferably fixed to one of the side surfaces of the first housing 16. A dashed line is drawn in a portion of the first housing 16 where the protruding portion 14a can be positioned. The first housing 16 contains a metal material, and thus is suitable for fixing the protruding portion 14a. Needless to say, the protruding portion 14a may be fixed to one of the side surfaces of the second housing 17.

Such a simple structure can prevent the overcooling state. Preventing the overcooling state is preferable, in which case the output characteristics of the battery cell are not degraded.

### Structure Example 2

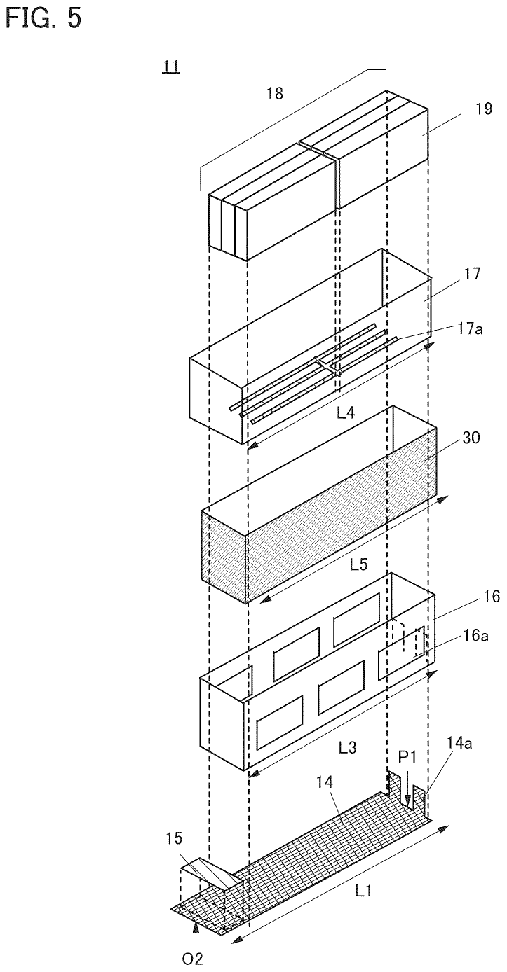

FIG. 5 illustrates a structure different from Structure example 1. As illustrated in FIG. 5, in addition to the first housing 16 and the second housing 17, a third housing 30 including a heat-insulating member may be included in the battery module 11 described in Structure example 1. The heat-insulating member refers to a member whose thermal conductivity is lower than that of a member forming the first housing 16 or a member forcing the second housing 17. For the heat-insulating member, one selected from an epoxy resin, glass fiber, and a composite material thereof can be used.

The heat-insulating member is preferably placed on a surface except the surface where the heat dissipation mechanism 14 is positioned. FIG. 5 illustrates the third housing 30 in which an insulating member is used for its side surface. The third housing 30 is preferably positioned outside the first housing 16. The third housing 30 is preferably positioned between the first housing 16 and the second housing 17. Thus, a length L5 of a side of the third housing 30 is preferably longer than the length L4 of the side of the second housing 17 and shorter than the length L3 of the side of the first housing 16. The above description of the length L5 is a description about a long side, and the same applies to a short side of the third housing 30. As illustrated in FIG. 5, it is preferable that the heat-insulating member of the third housing 30 be placed to overlap with the opening portion 16a of the first housing 16 because the temperature of the cell block 18 can be maintained. In the third housing 30, an opening portion corresponding to a region where the heat dissipation mechanism 14 is moved may be provided.

Needless to say, the third housing 30 may be positioned inside the first housing 16. Needless to say, the third housing 30 may be positioned outside the second housing 17.

The third housing 30 can be omitted when part of the first housing 16 includes the heat-insulating member. For example, the heat-insulating member is preferably used for whole or part of the side surface of the first housing 16. The third housing can be omitted when part of the second housing 17 includes the heat-insulating member. The heat-insulating member is preferably used for whole or part of the side surface of the second housing 17.

Such a simple structure can prevent the overcooling state. Preventing the overcooling state is preferable, in which case the output characteristics of the battery cell are not degraded.

### Structure Example 3

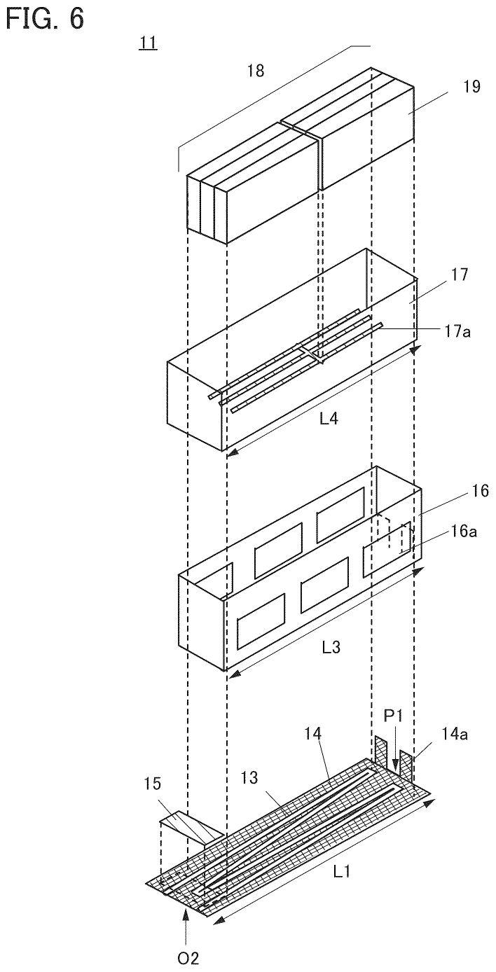

FIG. 6 illustrates a structure different from Structure example 1. As illustrated in FIG. 6, a heat sink capable of forced cooling can be used for the heat dissipation mechanism 14 in the battery module 11 described in Structure example 1. The heat sink preferably includes a tube 13. A liquid or a gas can be made to flow to the tube 13, and the tube 13 preferably has an inlet for introducing a liquid or a gas and an outlet for releasing a liquid or a gas. Although FIG. 6 illustrates the case where the inlet and the outlet are provided on the same side, the side where the inlet is positioned may be different from the side where the outlet is positioned. The inlet is preferably provided on the side including the point O2 of the heat dissipation mechanism 14.

A cooling solution is used as the liquid that passes through the tube 13, and air in a vehicle is used as the gas. In the case of using air in the vehicle, the side of the heat dissipation mechanism 14 where the inlet is provided is preferably closer to the front end of the vehicle, and the outlet is preferably closer to the rear portion of the vehicle. Furthermore, in the case of utilizing forced cooling, a fan may be added to the heat dissipation mechanism 14. For example, when a combination of a fan and a heat sink is used for the heat dissipation mechanism 14, efficient heat radiation can be achieved.

Furthermore, the above-described third housing of Structure example 2 may be used in this structure.

Such a simple structure can prevent the overcooling state. Preventing the overcooling state is preferable, in which case the output characteristics of the battery cell are not degraded.

### Structure Example 4

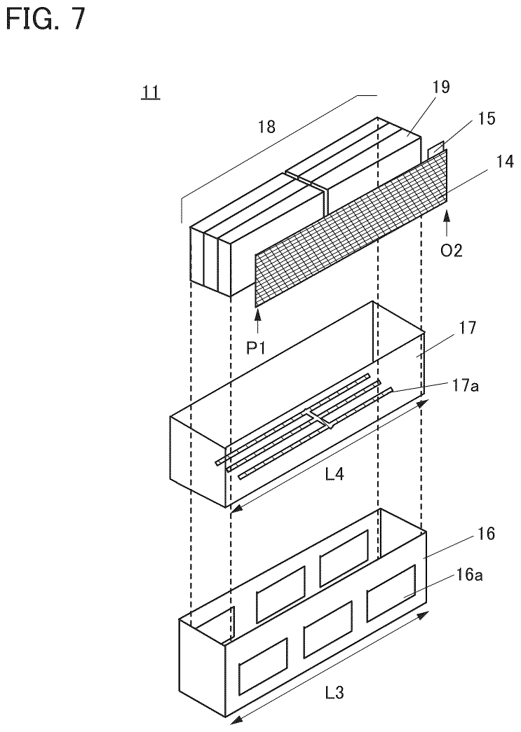

FIG. 7 illustrates a structure different from Structure example 1. As illustrated in FIG. 7, in the battery module 11 described in Structure example 1, the switching mechanism 15 and the heat dissipation mechanism 14 can be placed along the side surface of the cell block 18. The switching mechanism 15, the heat dissipation mechanism 14, and the cell block 18 can be held inside the second housing 17.

A side including the point O2 is moved with a side including the point P1 as a fulcrum in the heat dissipation mechanism 14. Therefore, in the second housing 17, an opening portion is preferably provided on a surface corresponding to the heat dissipation mechanism 14.

The heat dissipation mechanism 14 can be placed in the vicinity of the cell block 18, which is preferable because heat radiation can be performed sufficiently.

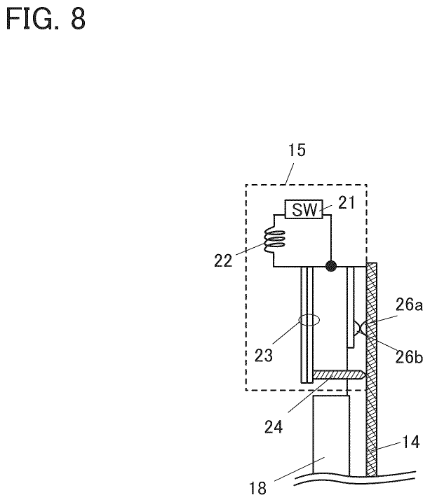

FIG. 8 illustrates the switching mechanism 15 using a bimetal switch. FIG. 8 corresponds to the above-described state A. In the case of the overcooling state, i.e., the above-described state B, the bimetal member 23 in FIG. 8 is projected on the right side as illustrated in FIG. 3B; thus, the pin 24 moves to the heat dissipation mechanism 14 side, whereby the cell block 18 and the heat dissipation mechanism 14 can be separated from each other. According to FIG. 8, the pin 24 moves in a direction intersecting with the gravity direction, which is preferable because the influence of the vibration of the vehicle 100 on the movement of the pin 24 can be reduced.

Furthermore, the above-described third housing and the like of Structure example 2 may be used in this structure example. Note that the position of the heat-insulating member is preferably different, and the heat-insulating member is preferably positioned on a side surface of the cell block 18 where the heat dissipation mechanism 14 is not provided or a bottom surface. Furthermore, the above-described heat sink and the like of Structure example 3 may be used in this structure example.

Such a simple structure can prevent the overcooling state. Preventing the overcooling state is preferable, in which case the output characteristics of the battery cell are not degraded.

### Structure Example 5

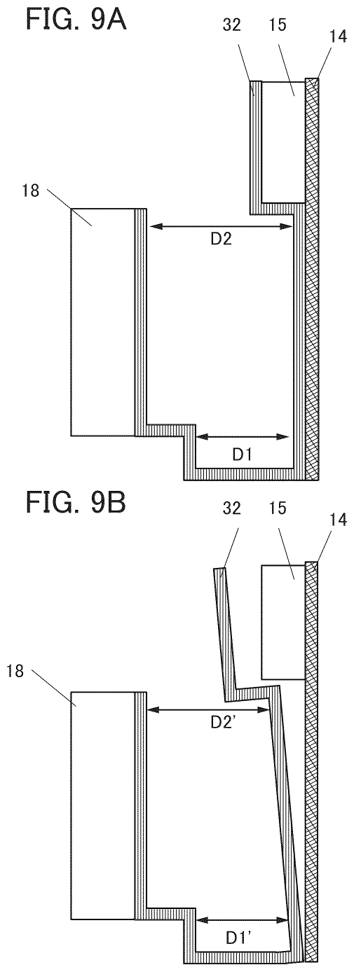

FIG. 9A and FIG. 9B illustrate structures different from Structure example 4. As illustrated in FIG. 9A and FIG. 9B, a heat transfer plate 32 is placed between the cell block 18 and the heat dissipation mechanism 14. Since aluminum, copper, or the like which has high thermal conductivity is used for the heat transfer plate 32, the temperature of the heat transfer plate 32 can be kept equal to or substantially equal to the temperature of the cell block 18. One end of the heat transfer plate 32 includes a region in contact with the cell block 18. The other end of the heat transfer plate 32 includes a region in contact with the heat dissipation mechanism 14. At the other end, the switching mechanism 15 is preferably positioned between the heat transfer plate 32 and the heat dissipation mechanism 14. Furthermore, a region other than the one end and the other end of the heat transfer plate 32 is preferably bent concavely. By such concave bending, the switching mechanism 15 can be placed to overlap with the cell block 18. As illustrated in FIG. 9A, a distance D1 between two opposite points of the heat transfer plate 32 in the bent region is preferably shorter than a distance D2 between two opposite points of the heat transfer plate 32 in the region where the switching mechanism 15 is positioned. Note that the above-described distances are different between FIG. 9A and FIG. 9B, and thus distances D1′ and D2′ are shown in FIG. 9B.

FIG. 9A is a normal state and corresponds to the above-described state A, and heat of the cell block 18 can be released from the heat dissipation mechanism 14 through the heat transfer plate 32. Other structures are as described above.

In FIG. 9B, the cell block 18 is in the overcooling state which corresponds to the above-described state B. Specifically, in the separated state, the distance between the position of the heat transfer plate 32 and the position of the heat dissipation mechanism 14 is larger than that in the above-described state A by using the switching mechanism 15. When the positions are separate from each other, the temperature of the cell block 18 and the temperature of the heat dissipation mechanism 14 are independent of each other, and the temperature of the cell block 18 is controlled to be different from that of the heat dissipation mechanism 14. Other structures are as described above.

The states in FIG. 9A and FIG. 9B can be switched by moving the heat transfer plate 32 with the use of the switching mechanism 15 as described above. Since the heat transfer plate 32 is moved in this structure example, a highly safe battery pack can be provided.

Although not illustrated in FIG. 9A and FIG. 9B, the heat transfer plate 32 positioned on the cell block 18 side may be moved by the switching mechanism 15.

Furthermore, the above-described third housing and the like of Structure example 2 may be used in this structure example. Note that the position of the heat-insulating member is preferably different, and the heat-insulating member is preferably positioned on a side surface of the cell block 18 where the heat dissipation mechanism 14 is not provided or a bottom surface. Furthermore, the above-described heat sink and the like of Structure example 3 may be used in this structure example. Furthermore, in this structure example, the heat dissipation mechanism 14 may be placed on the bottom surface side of the cell block 18 as in Structure example 1.

Such a simple structure can prevent the overcooling state. Preventing the overcooling state is preferable, in which case the output characteristics of the battery cell are not degraded.

### Structure Example 6

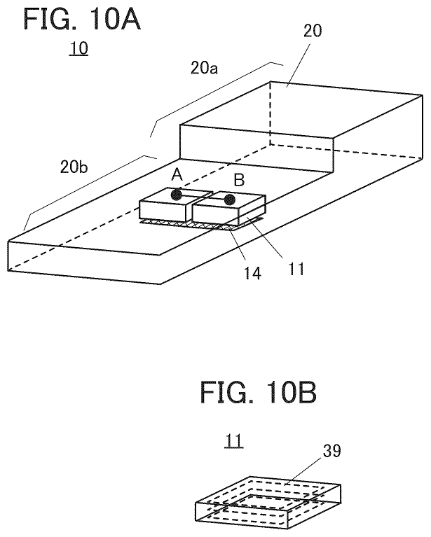

FIG. 10A and FIG. 10B illustrate structures different from Structure example 1. As illustrated in FIG. 10A and FIG. 10B, the battery module 11 includes a battery cell 39, and a laminated battery cell can be used as the battery cell 39. In the battery module 11, the battery cell 39 preferably has a stacked structure. In the case of using a laminated battery cell, the battery cell 39 can have a structure where laminated battery cells can be stacked by being sequentially contained in the battery cell 39 without a guide, a new housing, or the like so as to be the battery module 11. That is, in the case of a laminated battery cell, the number of guides and new housings included in the battery module 11 can be reduced. Needless to say, a spacer or the like may be placed to determine the position of the battery cell 39, that is, the positions of a plurality of battery cells.

In the second portion 20b of the case 20, the battery modules 11 can be laid without overlapping with each other. In the first portion 20a of the case 20, the battery modules 11 can overlap with each other. In the first portion 20a, the direction of the battery module can be laid vertically.

The heat dissipation mechanism 14 can be shared by at least two or more battery modules. FIG. 10A illustrates the case where the two battery modules share the heat dissipation mechanism 14.

Furthermore, the above-described structure of Structure example 2 to Structure example 5 may be employed in this structure example.

Such a simple structure can prevent the overcooling state. Preventing the overcooling state is preferable, in which case the output characteristics of the battery cell are not degraded.

### Structure Example 7

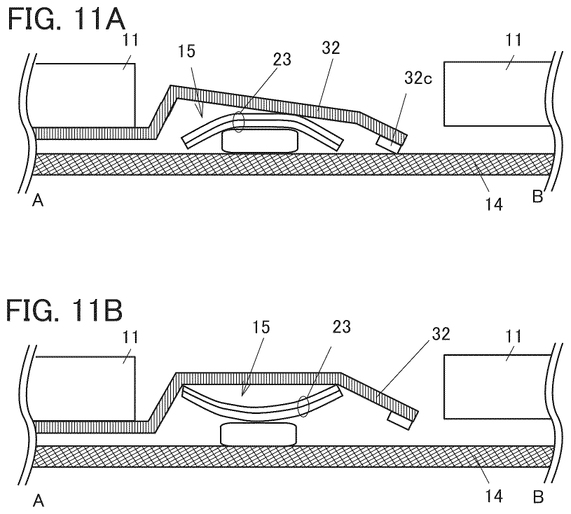

FIG. 11A and FIG. 11B are cross-sectional views corresponding to A-B illustrated in FIG. 10A, and show an example of a structure including the heat transfer plate 32 in Structure example 6. Note that a bimetal switch is used as the switching mechanism 15, and the pin can be omitted by using the heat transfer plate 32.

As illustrated in FIG. 11A and FIG. 11B, the switching mechanism 15 can be positioned between the battery modules 11. The bimetal switch is a small switch and is suitable when it is positioned between the battery modules 11. One end of the heat transfer plate 32 is provided to be in contact with the battery module 11. Furthermore, the larger the region of the heat transfer plate 32 in contact with the battery module 11 is, the more easily the temperature of the battery module 11 is sensed. For example, it is preferable that the heat transfer plate 32 be in contact with a given surface of the battery module 11 with an area of 80% or more, preferably 90% or more. The battery module 11 placed as illustrated in FIG. 10 is preferable because the bottom surface of the battery module 11 can be in contact with the heat transfer plate 32 and thus the temperature can be easily sensed. Note that although the temperature of the battery module 11 is the temperature of the housing of the battery module, the temperature of an exterior body of the battery cell 39 may be sensed. When the one end of the heat transfer plate 32 is placed inside the battery module 11, the temperature of the exterior body can be sensed.

Furthermore, the other end of the heat transfer plate 32 includes a region in contact with the heat dissipation mechanism 14. In FIG. 11A, the heat transfer plate 32 includes a projection 32c in order to easily contact with the heat dissipation mechanism 14, and the projection 32c is a contact point between the heat dissipation mechanism 14 and the heat transfer plate 32.

Furthermore, a region other than one end and the other end of the heat transfer plate 32 is in contact with the bimetal member 23. Thus, the state of the bimetal member 23 can be changed in accordance with the temperature of the heat transfer plate 32.

FIG. 11A illustrates a state where the heat transfer plate 32 controlled by the switching mechanism 15 includes a region in contact with the heat dissipation mechanism 14. A state in FIG. 11A where the heat transfer plate 32 and the heat dissipation mechanism 14 are in contact with each other is included in the close state, and thus the state in FIG. 11A corresponds to the above-described state A. The temperature of the battery module 11 is substantially equal to that of the heat dissipation mechanism 14, and can be in a temperature range suitable for charging and discharging.

FIG. 11B illustrates a state where the heat transmitting plate 32 controlled by the switching mechanism 15 is separated from the heat dissipation mechanism 14. The state in FIG. 11B corresponds to the above-described state B. Since the temperature of the battery module 11 is independent of the temperature of the heat dissipation mechanism 14 decreased in accordance with the outside temperature, the overcooling state can be prevented.

After that, changing the state in FIG. 11B to the state in FIG. 11A can prevent the overcooling state of the battery module 11, which is preferable.

Furthermore, the above-described structure of Structure example 2 to Structure example 5 may be employed in this structure example.

Such a simple structure can prevent the overcooling state. Preventing the overcooling state is preferable, in which case the output characteristics of the battery cell are not degraded.

### Structure Example 8

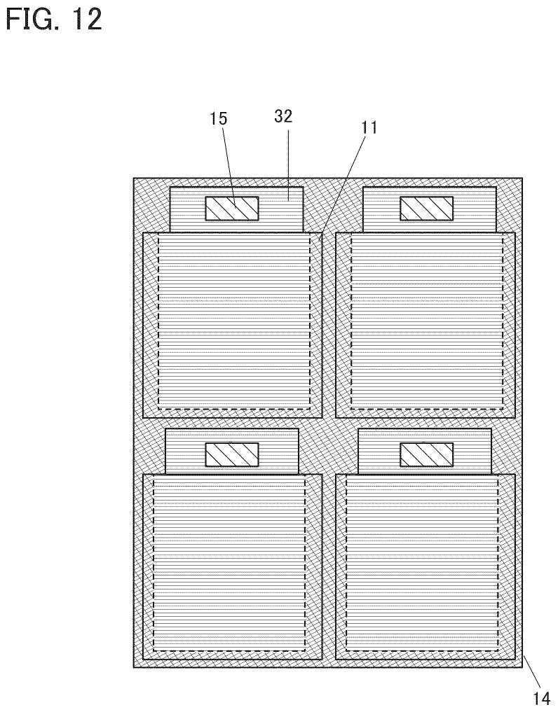

FIG. 12 is a plan view (also referred to as a top view) showing a state where the plurality of battery modules 11 share the heat dissipation mechanism 14. FIG. 12 shows an example of the positional relation between the heat dissipation mechanism 14, the switching mechanism 15, the heat transfer plate 32, the battery modules 11, and the like.

The plurality of battery modules 11 can be arranged orderly to overlap with the heat dissipation mechanism 14 and can be in contact with each other on a side where the bimetal member is not placed. A variation in temperature is reduced between the battery modules 11 whose parts are in contact with each other, which is preferable.

The larger the area where the heat transfer plate 32 overlaps with the battery module 11 is, the more easily the temperature is sensed, which is preferable. For example, as illustrated in FIG. 12, the heat transfer plate 32 preferably has a large first region overlapping with the battery module 11 in a plan view. Specifically, the heat transfer plate 32 preferably has the larger first region than a second region not overlapping with the battery module 11. Moreover, the switching mechanism 15 is preferably positioned in the second region.

Since the heat transfer plate 32 is provided for one battery module in FIG. 12, the overcooling state of each battery module 11 can be prevented individually even when the temperatures of the battery modules 11 vary from one another.

Furthermore, the above-described structure of Structure example 2 to Structure example 5 may be employed in this structure example.

Such a simple structure can prevent the overcooling state. Preventing the overcooling state is preferable, in which case the output characteristics of the battery cell are not degraded.

### Structure Example 9

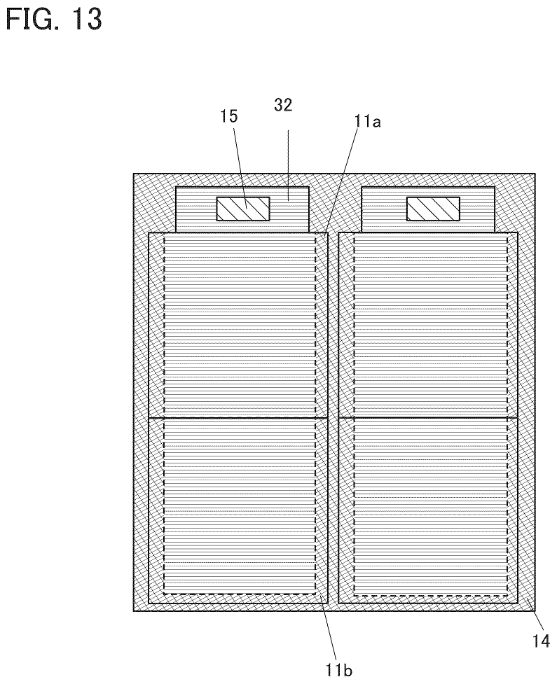

A positional relation between the heat dissipation mechanism 14, the switching mechanism 15, the heat transfer plate 32, the battery modules 11, and the like, which is different from that in FIG. 12, is described with reference to a plan view illustrated in FIG. 13. A structure in which surfaces on one side of battery modules are in contact with each other in order to reduce a temperature variation between the battery modules is described with the use of a first battery module 11a and a second battery module 11b. The first battery module 11a and the second battery module 11b are arranged orderly to overlap with the heat dissipation mechanism 14 and their surfaces on one side are in contact with each other. Since a variation in temperature is reduced between the plurality of battery modules including a contact surface, the first battery module 11a and the second battery module 11b can share the switching mechanism 15 and the heat transfer plate 32.

The heat transfer plate 32 can sense the temperature of each of the first battery module 11a and the second battery module 11b at the same time. Sensing at the same time includes sensing the average value of the temperature of the first battery module 11a and the temperature of the second battery module 11b.

The larger the area where the heat transfer plate 32 overlaps with the battery module is, the more easily the temperature is sensed; thus, as illustrated in FIG. 13, the heat transfer plate 32 is preferably provided to have a large area to overlap with the first battery module 11a and the second battery module 11b. The bimetal member 23 is preferably placed in a region not overlapping with the first battery module 11a and the second battery module 11b.

This structure is preferable because the number of components can be reduced, and thus the first battery module 11a, the second battery module 11b, and the like can be effectively arranged. Furthermore, a reduction in the number of components can achieve a reduction in the size of the battery pack.

### Structure Example 10

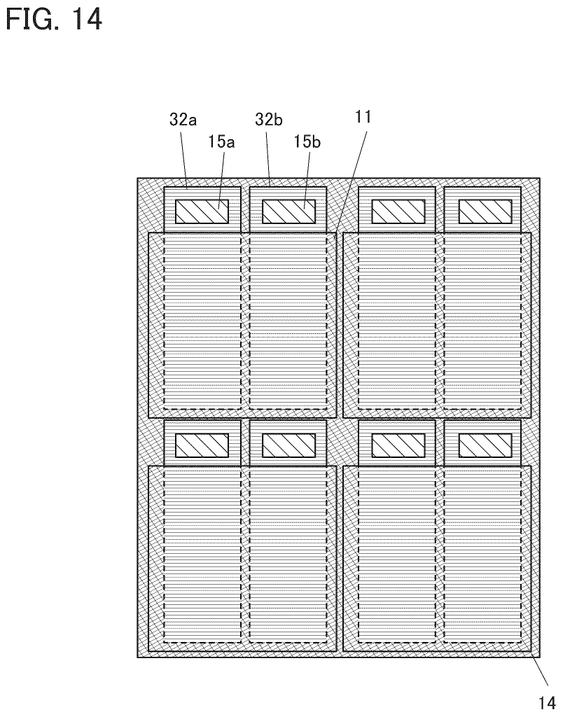

A positional relation between the heat dissipation mechanism 14, the switching mechanism, the heat transfer plate, the battery modules 11, and the like, which is different from that in FIG. 12 and FIG. 13, is described with reference to a plan view illustrated in FIG. 14. FIG. 14 shows an example of a structure in which a first switching mechanism 15a and a second switching mechanism 15b are provided for one battery module. A first heat transfer plate 32a and a second heat transfer plate 32b are provided to correspond to the switching mechanisms.

The temperature characteristics of the first switching mechanism 15a and the second switching mechanism 15b are preferably different from each other. For example, it is preferable that the first switching mechanism 15a start deformation when the temperature of the battery module 11 becomes lower than 15° C. and the second switching mechanism 15b start deformation when the temperature of the battery module 11 becomes lower than or equal to 0° C. Although the above temperatures are just examples, the temperature difference is preferably larger than or equal to 5° C.

The above first switching mechanism 15a can move the first heat transfer plate 32a. Thus, when the temperature becomes lower than 15° C., the first heat transfer plate 32a can be separated from the heat dissipation mechanism 14 first in accordance with the first switching mechanism 15a, and then when the temperature becomes lower than 0° C., the second heat transfer plate 32b can be separated from the heat dissipation mechanism 14 in accordance with the second switching mechanism 15b. As described above, the accuracy of the temperature control can be increased.

Furthermore, the above-described structure of Structure example 2 to Structure example 5 may be employed in this structure example.

Such a simple structure can prevent the overcooling state. Preventing the overcooling state is preferable, in which case the output characteristics of the battery cell are not degraded.

### Structure Example 11

Although not illustrated, a curved battery cell can also be used as the battery cell.

### Usage Example 1

An example of using the battery module 11 where the temperature suitable for charging is 35° C.±10° C. (which can be referred to as a temperature range higher than or equal to 25° C. and lower than or equal to 45° C.) is described. For example, when the vehicle 100 is stopped for charging, the heat dissipation mechanism 14 is close to the cell block 18. At this time, when the outside temperature is 30° C., the temperature of the heat dissipation mechanism 14 is approximately 30° C., and the temperature of the cell block 18 is retained at 30° C. and in the vicinity thereof. The vicinity refers to temperatures within ±3° C. Even in the case where the temperature of the cell block 18 starts to increase owing to charging, the heat of the cell block 18 is released so as to have substantially the same temperature as the heat dissipation mechanism 14.

The case where the outside temperature is below freezing, e.g., 0° C., in the same situation as described above is described. The temperature of the heat dissipation mechanism 14 is approximately 0° C., and the temperature of the cell block 18 is also 0° C. and the vicinity thereof. Since the temperature range suitable for charging and discharging of the cell block 18 is higher than or equal to 25° C. and lower than or equal to 45° C., the separation between the cell block 18 and the heat dissipation mechanism 14 is preferably started with the use of the switching mechanism 15 when the temperature of the cell block 18 decreases toward 0° C., specifically, when the temperature becomes lower than 15° C., for example. In other words, the cell block 18 and the heat dissipation mechanism 14 are preferably separated from each other before reaching 0° C. In this manner, the overcooling state can be prevented during charging. When the temperature of a battery module is lower than a temperature suitable for charging and discharging, rapid charging becomes difficult; meanwhile, the battery pack of one embodiment of the present invention is suitable for rapid charging because the overcooling state is prevented. It can be considered that vibration of the vehicle 100 has no influence when the vehicle is stopped.

### Usage Example 2

In the battery pack 10 of one embodiment of the present invention, the use of the switching mechanism 15 can prevent the overcooling state of the battery module 11 even when the battery module 11 is discharged while the vehicle 100 is stopped, which is preferable. For the movement of the switching mechanism 15 and the like, refer to Usage example 1. It can be considered that vibration of the vehicle 100 has no influence when the vehicle is stopped.

### Usage Example 3

In the battery pack 10 of one embodiment of the present invention, the use of the switching mechanism 15 can prevent the overcooling state of the battery module 11 even when the battery module 11 is discharged while the vehicle 100 is moving, which is preferable. For the movement of the switching mechanism 15 and the like, refer to Usage example 1. While the vehicle 100 is moving, it is preferable to use the switching mechanism 15 and the like which move in a direction intersecting with the gravity direction shown in the above Structure example 4 and the like, in consideration of the influence of vibration of the vehicle 100.

### Usage Example 4

In the battery pack 10 of one embodiment of the present invention, the use of the switching mechanism 15 can prevent the overcooling state of the battery module 11 even when the battery module 11 is charged while the vehicle 100 is moving, which is preferable. For the movement of the switching mechanism 15 and the like, refer to Usage example 1. Regenerative charging is included in the state of being moved and being charged. While the vehicle 100 is moving, it is preferable to use the switching mechanism 15 and the like which move in a direction intersecting with the gravity direction shown in the above Structure example 4 and the like, in consideration of the influence of vibration of the vehicle 100.

The temperature suitable for charging in Usage example 1 to Usage example 4 can be determined from the specifications of the battery module 11. In addition, the temperature suitable for charging can be determined in consideration of the deterioration state of the battery module 11 with the use of the BMS. That is, the temperature used in Usage example 1 to Usage example 4 is one example, and the temperature is not limited to the above temperature.

This embodiment can be used in appropriate combination with the other embodiments.

### Embodiment 2

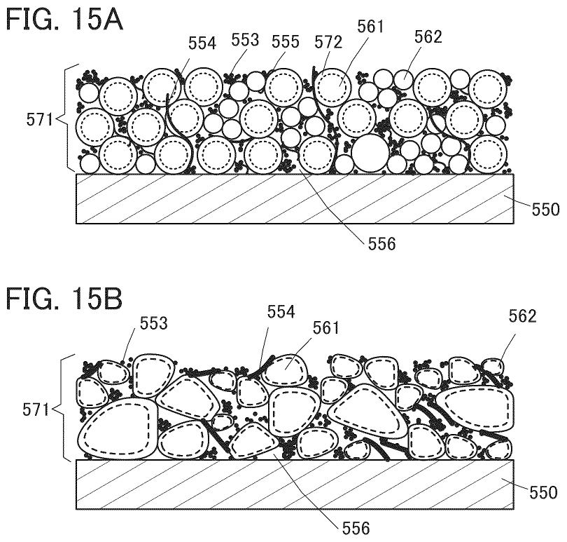

In this embodiment, a structure of a battery cell that can be used in the above embodiment is described. Specifically, a positive electrode of the battery cell is described with reference to FIG. 15.

### Positive Electrode

The battery cell includes a positive electrode. FIG. 15A illustrates an example of a cross-sectional view of the positive electrode. The positive electrode includes a positive electrode active material layer 571 over a positive electrode current collector 550. The positive electrode active material layer 571 includes a positive electrode active material 561, a positive electrode active material 562, a binder (binding agent) 555, a conductive additive 553, and an electrolyte 556.

### Positive Electrode Current Collector

The positive electrode includes the positive electrode current collector 550. For the positive electrode current collector 550, a material having high conductivity can be used; specifically, a metal such as copper, gold, platinum, aluminum, iron, or titanium, an alloy of the above metal, or the like is preferably used. Stainless steel can be given as an alloy of iron. For the positive electrode current collector 550, a metal or an alloy that does not dissolve at the potential of the positive electrode is preferably used. For the positive electrode current collector 550, an aluminum alloy to which an element that improves heat resistance, such as silicon, titanium, neodymium, scandium, or molybdenum, is added is preferably used. For the positive electrode current collector 550, a metal that forms silicide by reacting with silicon, such as the above-described titanium, is preferably used. Examples of the metal element that forms silicide by reacting with silicon include zirconium, hafnium, vanadium, niobium, tantalum, chromium, molybdenum, tungsten, cobalt, and nickel, in addition to the above-described titanium.

The thickness of the positive electrode current collector 550 is preferably greater than or equal to 5 μm and less than or equal to 30 μm, further preferably greater than or equal to 10 μm and less than or equal to 20 μm and is preferably a sheet-like shape or a plate-like shape. The positive electrode current collector 550 may be subjected to punching metal processing or expanded metal processing. The punching metal processing is perforation processing, and the expanded metal processing is cutting and stretching processing. When the punching metal processing and the expanded metal processing described above are performed, the positive electrode current collector 550 having a mesh shape provided with opening portions with a circular shape, an elliptical shape, a rhombus shape, or the like is obtained. With the use of the positive electrode current collector 550 having the above opening portions, a lightweight battery cell can be obtained.

### Positive Electrode Active Material

The positive electrode includes a positive electrode active material. Although the positive electrode active material 561 and the positive electrode active material 562 illustrated in FIG. 15A are sometimes referred to as positive electrode active material particles, the shape of the positive electrode active material is in any of a variety of forms other than a particle form. The positive electrode active material 561 and the positive electrode active material 562 may each be a primary particle or a secondary particle. Note that in this specification, the primary particle refers to a particle (lump) of the smallest unit having no grain boundary when being observed, for example, at a magnification of 5000 times with a SEM (scanning electron microscope) or the like. That is, the primary particle is a particle as a minimum unit. The secondary particle refers to a particle in which the above primary particles aggregate, partially sharing the above grain boundary (the circumference of the primary particle or the like), and which is independent of another particle. That is, the secondary particle has a grain boundary.

As each of the positive electrode active material 561 and the positive electrode active material 562, a material into and from which carrier ions can be inserted and extracted can be used. As the carrier ions, lithium ions, sodium ions, potassium ions, calcium ions, strontium ions, barium ions, beryllium ions, or magnesium ions can be used.

Examples of the material into and from which lithium ions can be inserted and extracted include lithium composite oxides with an olivine crystal structure, a layered rock-salt crystal structure, and a spinel crystal structure.

For example, a lithium composite oxide with an olivine crystal structure is represented by LiMPO₄ (here, M includes one or more of Fe, Mn, Ni, and Co). Since Fe and Mn are excellent in thermal stability, LiMPO₄ with M being either or both of Fe and Mn is suitable as the positive electrode active material. In the case where Fe is used as M, LiMPO₄ is expressed by LiFePO₄, which is referred to as LFP in some cases. LFP may be referred to as a composite oxide containing lithium, iron, and phosphorus and may contain an element other than the elements described as an example, or an element that does not contribute to capacitance.

A lithium composite oxide with a layered rock-salt crystal structure is, for example, represented by LiMO₂ (here, M includes one or more of Fe, Mn, Ni, and Co). In the case where Co is used as M, LiMO₂ is expressed by LiCoO₂, which is referred to as LCO or lithium cobalt oxide in some cases. LCO may be referred to as a composite oxide containing lithium and cobalt and may contain an element other than the elements described as an example, or an element that does not contribute to capacitance.

Lithium cobalt oxide may contain one or two or more elements selected from the group consisting of nickel, chromium, aluminum, iron, magnesium, molybdenum, zinc, zirconium, indium, gallium, copper, titanium, niobium, silicon, fluorine, phosphorus, and the like. Such an element is referred to as an additive element in some cases. The additive element is often positioned in a surface portion of the active material. The surface portion refers to a region from a surface of the active material to 50 nm, preferably to 30 nm, further preferably to 10 nm.

Furthermore, as a lithium composite oxide with a layered rock-salt crystal structure, there is a NiCoMn-based material represented by LiNiₓCo_{y}Mn_{z}O₂ (x>0, y>0, and 0.8<x+y+z<1.2). LiNiₓCo_{y}Mn_{z}O₂ (x>0 , y>0, and 0.8<x+y+z<1.2) is referred to as NCM in some cases. In LiNiₓCo_{y}Mn_{z}O₂, for example, it is preferable to satisfy 0.1x<y<8x and 0.1x<z<8x. As a specific example, x, y, and z preferably satisfy x:y:z=1:1:1 or the value in the vicinity thereof. As another specific example, x, y, and z preferably satisfy x:y:z=5:2:3 or the value in the vicinity thereof. As another specific example, x, y, and z preferably satisfy x:y:z=8:1:1 or the value in the vicinity thereof. As another specific example, x, y, and z preferably satisfy x:y:z=9:0.5:0.5 or the value in the vicinity thereof. As another specific example, x, y, and z preferably satisfy x:y:z=6:2:2 or the value in the vicinity thereof. As another specific example, x, y, and z preferably satisfy x:y:z=1:4:1 or the value in the vicinity thereof. NCM may be referred to as a lithium composite oxide containing Ni, Co, and Mn or may be referred to as a composite oxide containing Li, Ni, Co, and Mn.

In addition, the above NCM may contain one or two or more selected from calcium, boron, gallium, aluminum, boron, and indium at a concentration higher than or equal to 0.1 at % and lower than or equal to 3 at %. In some cases, calcium, boron, gallium, aluminum, boron, and indium at the above-described concentration are referred to as additive elements. The additive element is often positioned in a surface portion of the active material. The surface portion refers to a region from a surface of the active material to 50 nm, preferably to 30 nm, further preferably to 10 nm.

In addition, a NiCoMn-based lithium composite oxide containing aluminum as its main component is sometimes referred to as NCMA. In some cases, NCMA is referred to as a lithium composite oxide containing Ni, Co, Mn, and Al or is referred to as a composite oxide containing Li, Ni, Co, Mn, and Al.

In addition, a lithium composite oxide containing Ni and Co and containing aluminum as its main component is sometimes referred to as NCA. In some cases, NCA is referred to as a lithium composite oxide containing Ni, Co, and Al or is referred to as a composite oxide containing Li, Ni, Co, and Al.

For example, examples of a lithium composite oxide with a spinel crystal structure include a lithium manganese spinel (LiMn₂O₄).

Other examples of the material into and from which sodium ions can be inserted and extracted include NaFeO₂, NaNiO₂, NaCoO₂, NaMnO₂, NaVO₂, Na(Ni_{X}Mn_{1-X})O₂ (0<X<1), Na(Fe_{X}Mn_{1-X})O₂ (0<X<1), NaVPO₄F, Na₂FePO₄F, and Na₃V₂(PO₄)₃.

In addition, oxides such as V₂O₅ and Nb₂O₅ have been researched as positive electrode active materials.

A median diameter (D50) of the positive electrode active material 561 is greater than or equal to 1 μm and less than or equal to 50 μm, preferably greater than or equal to 5 μm and less than or equal to 30 μm. Note that in the case of a lithium composite oxide represented by NCM, the positive electrode active material 561 exists in the form of a secondary particle in some cases. The secondary particle is regarded as a particle in which primary particles aggregate. In the case where the secondary particle is an aggregate of the primary particles that satisfy the above-described average particle diameter, the median diameter (D50) of the secondary particle is preferably greater than or equal to 10 μm and less than or equal to 100 μm, further preferably greater than or equal to 20 μm and less than or equal to 80 μm.

The positive electrode active material 562 having a different median diameter (D50) is further added in some cases to increase the filling density of the active material. The median diameter (D50) of the positive electrode active material 562 is preferably greater than or equal to ⅙ and less than or equal to 1/10 of the median diameter (D50) of the positive electrode active material 561. When the particle size distribution measurement is performed on an active material in which the positive electrode active material 561 and the positive electrode active material 562 are mixed, at least two peaks are observed; a local maximum value are observed at each peak, and the local maximum values are different from each other.

The charging density can be increased without the positive electrode active material 562. When the positive electrode active material 562 is not included, the number of formation steps can be reduced and furthermore, costs can be reduced.

The active material of the positive electrode active material 561 may be the same as or different from the active material of the positive electrode active material 562. The same active materials contain the same main material but may be different in the presence of an additive element or the like. The different active materials contain different main materials.

The positive electrode active material 561 and the positive electrode active material 562 may include an additive element, and the additive element is preferably positioned in the surface portion. The additive element is preferably unevenly distributed in the surface portion. Uneven distribution refers to a state where the additive element exists non-uniformly or unevenly and includes a state where the concentration of the additive element is higher in the surface portion. Uneven distribution may be expressed as segregation or precipitation.

FIG. 15A illustrates a surface portion 572 of the positive electrode active material 561. In a cross-sectional view, the surface portion 572 extends 50 nm or less, preferably 35 nm or less, further preferably 20 nm or less, most preferably 10 nm or less inward from the surface of the positive electrode active material 561. Although not illustrated, the positive electrode active material 562 may include a surface portion similar to the surface portion 572.

The structure of the active material including the surface portion 572 is referred to as a core shell structure in some cases.

### Binder

As illustrated in FIG. 15A, the positive electrode includes the binder 555. The binder 555 is provided to prevent the positive electrode active material 561, the positive electrode active material 562, or the conductive additive 553 from slipping off from the positive electrode current collector 550. The binder 555 has a function of fixing the positive electrode active material 561 and the conductive additive 553 to each other. Similarly, the binder 555 also has a function of fixing the positive electrode active material 562 and the conductive additive 553 to each other. Thus, there are the binder 555 positioned in contact with the positive electrode current collector 550, the binder 555 positioned between the positive electrode active material 561 and the conductive additive 553, the binder 555 positioned between the positive electrode active material 562 and the conductive additive 553, and the binder 555 positioned to be intertwined with the conductive additive 553.

As the binder 555, a rubber material such as styrene-butadiene rubber (SBR), styrene-isoprene-styrene rubber, acrylonitrile-butadiene rubber, butadiene rubber, or ethylene-propylene-diene copolymer is preferably used, for example. Fluororubber can also be used as the binder.

As the binder 555, for example, water-soluble polymers are preferably used. As the water-soluble polymers, a polysaccharide can be used, for example. As the polysaccharide, a cellulose derivative such as carboxymethyl cellulose (CMC), methyl cellulose, ethyl cellulose, hydroxypropyl cellulose, diacetyl cellulose, or regenerated cellulose, starch, or the like can be used. It is further preferable that such a water-soluble polymer be used in combination with any of the above rubber materials.

Alternatively, as the binder 555, a material such as polystyrene, poly(methyl acrylate), poly(methyl methacrylate) (PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, polyvinylidene fluoride (PVDF), polyacrylonitrile (PAN), ethylene-propylene-diene polymer, polyvinyl acetate, or nitrocellulose is preferably used.

Two or more of the above materials may be used in combination for the binder 555.

For example, a material having a significant viscosity modifying effect and another material may be used in combination as the binder 555. For example, a rubber material or the like has high adhesion and high elasticity but may have difficulty in viscosity modification when mixed in a solvent. In such a case, a rubber material or the like is preferably mixed with a material having a significant viscosity modifying effect, for example. As a material having a significant viscosity modifying effect, for instance, a water-soluble polymer is preferably used. As a water-soluble polymer having a significant viscosity modifying effect, the above-mentioned polysaccharide that is, for example, a cellulose derivative such as carboxymethyl cellulose (CMC), methyl cellulose, ethyl cellulose, hydroxypropyl cellulose, diacetyl cellulose, or regenerated cellulose or starch, can be used.

Note that a cellulose derivative such as carboxymethyl cellulose has a higher solubility when converted into a salt such as a sodium salt or an ammonium salt of carboxymethyl cellulose, and thus easily exerts an effect as a viscosity modifier. A high solubility can also increase the dispersibility of an active material or other components in the formation of a slurry for an electrode. In this specification and the like, cellulose and a cellulose derivative used as a binder of an electrode include salts thereof.

A water-soluble polymer stabilizes the viscosity by being dissolved in water and allows stable dispersion of the active material and another material combined as a binder, such as styrene-butadiene rubber, in an aqueous solution. Furthermore, a water-soluble polymer is expected to be easily and stably adsorbed onto an active material surface because it has a functional group. Many cellulose derivatives, such as carboxymethyl cellulose, have a functional group such as a hydroxyl group or a carboxyl group. Because of functional groups, polymers are expected to interact with each other and cover an active material surface in a large area.

In the case where the binder that covers or is in contact with the active material surface forms a film, the film is expected to serve also as a passivation film to inhibit the decomposition of the electrolyte solution. Here, a passivation film refers to a film without electric conductivity or a film with extremely low electric conductivity, and can inhibit the decomposition of an electrolyte solution at a potential at which a battery reaction occurs in the case where the passivation film is formed on the active material surface, for example. It is further desirable that the passivation film can conduct lithium ions while inhibiting electrical conduction.

### Conductive Additive

Since the positive electrode active material 561 being a composite oxide may have high resistance, it is difficult to collect a current from the positive electrode active material 561 to the positive electrode current collector 550. In that case, the positive electrode contains the conductive additive 553 and a conductive additive 554 as illustrated in FIG. 15A, and the conductive additive 553 and the conductive additive 554 have a function of giving aid to a current path between the positive electrode active material 561 and the positive electrode current collector 550, a current path between a plurality of the positive electrode active materials 561, a current path between a plurality of positive electrode active materials and the positive electrode current collector 550, and the like.

To serve such a function, the conductive additive 553 and the conductive additive 554 preferably contain a material having a lower resistance than the positive electrode active material 561. Furthermore, some of the conductive additive 553 and the conductive additive 554 are preferably placed so as to be in contact with the positive electrode current collector 550, and some of the conductive additive 553 and the conductive additive 554 are preferably placed in a gap between the positive electrode active materials 561. A conductive additive is also referred to as a conductivity-imparting agent or a conductive material owing to its role.

Note that the positive electrode may have a structure containing either one of the conductive additive 553 and the conductive additive 554.

As the conductive additive, a carbon material or a metal material is typically used. The conductive additive 553 is in a particle form; examples of the particulate conductive additive include carbon black (e.g., furnace black, acetylene black, or graphite). Carbon black mostly has a smaller grain diameter than the positive electrode active material 561. The conductive additive 554 is in a fibrous form; examples of the fibrous conductive additive include carbon nanotube (CNT) and VGCF (registered trademark). Other conductive additives are in a sheet form; examples of the sheet-shaped conductive additive include multilayer graphene. The sheet-shaped conductive additive sometimes looks like a thread in observation of a cross section of a positive electrode.

The conductive additive 553 in a particle form can enter a gap of the positive electrode active material 561 and easily aggregates. Thus, the particulate conductive additive 553 can give aid to a conductive path between positive electrode active materials provided close to each other. Although having a bent region, the conductive additive 554 in a fiber form is larger than the positive electrode active material 561. The conductive additive 554 in a fiber form can thus give aid to not only a conductive path between adjacent positive electrode active materials but also a conductive path between positive electrode active materials placed apart from each other. Conductive additives in two or more forms as described above are preferably mixed.

For example, a sheet-shaped conductive additive may be used instead of the fibrous conductive additive 554. In the case of using multilayer graphene as the sheet-shaped conductive additive and carbon black as a particulate conductive additive, the weight of the carbon black is preferably 1.5 times or more and 20 times or less, further preferably 2 times or more and 9.5 times or less of the weight of graphene in the state of slurry where these are mixed.

When the mixing ratio between multilayer graphene and carbon black is in the above-described range, carbon black does not aggregate and is easily dispersed. When the mixing ratio between multilayer graphene and carbon black is in the above-described range, the electrode density can be higher than that of the time when only carbon black is used as a conductive additive. As the electrode density is higher, the capacity per unit weight can be higher.

Moreover, when the mixing ratio between multilayer graphene and carbon black is in the above-described range, rapid charging is possible.

### Electrolyte

The battery cell includes an electrolyte. Although the electrolyte described in this embodiment is an organic solvent in which an electrolyte (lithium salt) is dissolved and can be referred to as an electrolyte solution, the electrolyte is not limited to an electrolyte containing an organic solvent which is liquid at normal temperature, and can also be a solid electrolyte. Alternatively, an electrolyte containing both an liquid electrolyte which is liquid at normal temperature and a solid electrolyte that is solid at normal temperature (this is referred to as a semisolid electrolyte) can be used. For example, the positive electrode in FIG. 15A is the electrolyte 556. Although not illustrated in FIG. 15A, a negative electrode described later also includes the electrolyte 556.

### Example of Electrolyte for Normal-Temperature Use

Examples of the electrolyte for normal-temperature use are described below.

As the organic solvent used for the electrolyte for normal-temperature use, an aprotic organic solvent is preferably used. For example, one of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more of these solvents can be used in an appropriate combination in an appropriate ratio.

The use of one or more ionic liquids (normal temperature molten salts) which have features of non-flammability and non-volatility as the organic solvent used for the electrolyte for normal-temperature use can prevent a battery cell from exploding, catching fire, and the like even when the battery cell internally shorts out or the internal temperature increases owing to overcharging or the like. An ionic liquid contains a cation and an anion, specifically, an organic cation and an anion. Examples of the organic cation used for the electrolyte include aliphatic onium cations such as a quaternary ammonium cation, a tertiary sulfonium cation, and a quaternary phosphonium cation, and aromatic cations such as an imidazolium cation and a pyridinium cation. Examples of the anion used for the electrolyte include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

As the lithium salt dissolved in the above-described organic solvent, for example, one or two or more selected from LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂) (CF₃SO₂), LiN(C₂F₅SO₂)₂, and the like can be used.

The above-described organic solvent may contain an additive. For example, vinylene carbonate (VC), propane sultone (PS), tert-butylbenzene (TBB), fluoroethylene carbonate (FEC), lithium bis(oxalate)borate (LiBOB), a dinitrile compound such as succinonitrile or adiponitrile, or the like may be added as the additive to the above-described organic solvent. The concentration of the additive in the whole electrolyte solution is, for example, higher than or equal to 0.1 wT % and lower than or equal to 5 wT %. It is particularly preferable to use VC or LiBOB because it enables favorable film formation.

As the organic solvent used for the electrolyte for normal-temperature use, a polymer gel electrolyte may be used. When a polymer gel electrolyte is used, safety against liquid leakage and the like is improved. Furthermore, the battery cell can be thinner and more lightweight.

As a polymer that undergoes gelation, a silicone gel, an acrylic gel, an acrylonitrile gel, a polyethylene oxide-based gel, a polypropylene oxide-based gel, a fluorine-based polymer gel, or the like can be used.

As the polymer, a polymer having a polyalkylene oxide structure, such as polyethylene oxide (PEO); PVDF; polyacrylonitrile; a copolymer containing any of them; or the like can be used, for example. For example, PVDF-HFP, which is a copolymer of PVDF and hexafluoropropylene (HFP), can be used. The formed polymer may be porous.

For the electrolyte for normal-temperature use, a solid electrolyte containing an inorganic material can be used. For example, a sulfide-based solid electrolyte, an oxide-based solid electrolyte, a halide-based solid electrolyte, or the like can be used. Alternatively, a solid electrolyte containing a high-molecular material such as a PEO (polyethylene oxide)-based high-molecular material can be used. When the solid electrolyte is used, a separator and a spacer do not need to be provided. Furthermore, the battery cell can be solidified; therefore, there is no possibility of liquid leakage and thus the safety of the battery cell is dramatically improved.

The sulfide-based solid electrolyte includes a thio-LISICON-based material (e.g., Li₁₀GeP₂S₁₂ or Li_{3.25}Ge_{0.25}P_{0.75}S₄), sulfide glass (e.g., 70Li₂S·30P₂S530Li₂S·26B₂S₃·44LiI, 63Li₂S·36SiS₂·1Li₃PO₄, 57Li₂S·38SiS₂·5Li₄SiO₄, or 50Li₂S·50GeS₂), or sulfide-based crystallized glass (e.g., Li₇P₃S₁₁ or Li_{3.25}P_{0.95}S₄). The sulfide-based solid electrolyte has advantages such as high conductivity of some materials, low-temperature synthesis, and ease of maintaining a path for electrical conduction after charge and discharge because of its relative softness.

Examples of the oxide-based solid electrolyte include a material having a perovskite crystal structure (e.g., La_{2/3-x}Li₃ₓTiO₃), a material having a NASICON crystal structure (e.g., Li₁₊ₓAlₓTi₂₋ₓ(PO₄)₃), a material having a garnet crystal structure (e.g., Li₇La₃Zr₂O₁₂), a material having a LISICON crystal structure (e.g., Li₁₄ZnGe₄O₁₆), LLZO (Li₇La₃Zr₂O₁₂), oxide glass (e.g., Li₃PO₄—Li₄SiO₄ and 50Li₄SiO₄·50Li₃BO₃), and oxide-based crystallized glass (e.g., Li_{1.07}Al_{0.69}Ti_{1.46}(PO₄)₃ and Li_{1.5}Al_{0.5}Ge_{1.5}(PO₄)₃). The oxide-based solid electrolyte has an advantage of stability in the air.

Examples of the halide-based solid electrolyte include LiAlCl₄, Li₃InBr₆, LiF, LiCl, LiBr, and LiI. Moreover, a composite material in which pores of porous aluminum oxide or porous silica are filled with such a halide-based solid electrolyte can also be used as the solid electrolyte.

Alternatively, different solid electrolytes may be mixed and used.

In particular, Li₁₊ₓAlₓTi₂₋ₓ(PO₄)₃ (0<x<1) having a NASICON crystal structure (hereinafter, LATP) is preferable because LATP contains aluminum and titanium, each of which is the same element as the main material or the additive element of the positive electrode active material used in one embodiment of the present invention, and thus a synergistic effect of improving the cycle performance is expected. Moreover, higher productivity due to the reduction in the number of steps is expected. Note that in this specification and the like, a NASICON crystal structure refers to a compound that is represented by M₂(AO₄)₃ (M: transition metal; A: S, P, As, Mo, W, or the like) and has a structure in which MO₆ octahedra and AO₄ tetrahedra that share corners are arranged three-dimensionally.

### Example of Electrolyte for Low-Temperature Use

Examples of an electrolyte for low-temperature use are described below.

An organic solvent of the electrolyte for low-temperature use contains ethylene carbonate (EC), ethyl methyl carbonate (EMC), and dimethyl carbonate (DMC). When a total content of the ethylene carbonate, the ethyl methyl carbonate, and the dimethyl carbonate is 100 vol %, an organic solvent in which the volume ratio between the ethylene carbonate, the ethyl methyl carbonate, and the dimethyl carbonate is x:y:100-x-y (where 5≤x≤35 and 0<y<65) can be used. More specifically, an organic solvent containing EC, EMC, and DMC at EC:EMC:DMC=30:35:35 (volume ratio) can be used. Note that the above volume ratio may be a volume ratio of the electrolyte solution before mixing, and the electrolyte solution may be mixed at room temperature (typically 25° C.).

EC is cyclic carbonate and has high relative dielectric constant, and thus has an effect of promoting dissociation of a lithium salt. Meanwhile, the EC has high viscosity and has a high freezing point (melting point) of 38° C.; thus, EC is difficult to use in a low-temperature environment when EC is used alone as the organic solvent. Then, the organic solvent specifically described in one embodiment of the present invention includes not only EC but also EMC and DMC. EMC is a chain-like carbonate and has an effect of decreasing the viscosity of the electrolyte solution, and the freezing point is −54° C. In addition, DMC is also a chain-like carbonate and has an effect of decreasing the viscosity of the electrolyte solution, and the freezing point is −43° C. An electrolyte formed using an organic solvent in which EC, EMC, and DMC having such physical properties are mixed in a volume ratio of x:y:100-x-y (5≤x≤35 and 0<y<65) at 25° C. when the total content of these three organic solvents is 100 vol % has a characteristic in which the freezing point is lower than or equal to −40° C.

A general electrolyte used for a battery cell is solidified at approximately −20° C.; thus, it is difficult to fabricate a battery that can be charged and discharged at −40° C. Since the electrolyte described above as the organic solvent of the electrolyte for low-temperature use has a freezing point lower than or equal to −40° C., a battery cell that can be charged and discharged even in an extremely low-temperature environment such as at −40° C. can be obtained.

A lithium salt dissolved in the organic solvent of the electrolyte for low-temperature use can be selected from the lithium salts described as the lithium salt of the electrolyte for normal-temperature use.

The additive contained in the organic solvent of the electrolyte for low-temperature use can be selected from the additives described as the additives of the electrolyte for normal-temperature use.

As already described above, although FIG. 15A illustrates the positive electrode active material 561 in a particle form, the positive electrode active material 561 is not necessarily in a particle form. As illustrated in FIG. 15B, the cross-sectional shape of the positive electrode active material 561 may be an ellipse, a rectangle, a trapezoid, a pyramid, a quadrilateral with rounded corners, or an asymmetrical shape. Note that by pressing in the formation process of the positive electrode, the particulate positive electrode active material sometimes changes in shape to have the shape as illustrated in FIG. 15B. The other components in FIG. 15B are similar to those in FIG. 15A and are not described.

### Negative Electrode

The battery cell includes a negative electrode. The negative electrode includes a negative electrode active material layer and a negative electrode current collector. The negative electrode active material layer includes a negative electrode active material, and may further contain a conductive additive and a binder.

### Negative Electrode Current Collector

The negative electrode includes a negative electrode current collector. For the negative electrode current collector, a material similar to that of the positive electrode current collector can be used.

### Negative Electrode Active Material

The negative electrode includes a negative electrode active material. As the negative electrode active material, an alloy material or a carbon material can be used, for example.

As the negative electrode active material, an element that enables charge and discharge reaction by alloying reaction and dealloying reaction with lithium can be used. For example, a material containing at least one of silicon, tin, gallium, aluminum, germanium, lead, antimony, bismuth, silver, zinc, cadmium, indium, and the like can be used. Such elements have higher capacity than carbon. In particular, silicon has a high theoretical capacity of 4200 mAh/g. For this reason, silicon is preferably used as the negative electrode active material. Alternatively, a compound containing any of the above elements may be used. Examples of the compound include SiO, Mg₂Si, Mg₂Ge, SnO, SnO₂, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, and SbSn. Here, an element that enables charge and discharge reactions by an alloying and a dealloying reaction with lithium and a compound containing the element, for example, are referred to as alloy materials in some cases.

In this specification and the like, SiO refers, for example, to silicon monoxide. Note that SiO can alternatively be expressed as SiOₓ. Here, it is preferable that x be 1 or have an approximate value of 1. For example, x is preferably greater than or equal to 0.2 and less than or equal to 1.5, or preferably greater than or equal to 0.3 and less than or equal to 1.2.

As the carbon material, graphite, graphitizing carbon (soft carbon), non-graphitizing carbon (hard carbon), carbon fiber (carbon nanotube), graphene, carbon black, or the like is used.

Examples of graphite include artificial graphite and natural graphite. Examples of artificial graphite include mesocarbon microbeads (MCMB), coke-based artificial graphite, and pitch-based artificial graphite. As artificial graphite, spherical graphite having a spherical shape can be used. For example, MCMB is preferably used because it may have a spherical shape. Moreover, MCMB may preferably be used because it can relatively easily have a small surface area. Examples of natural graphite include flake graphite and spherical natural graphite.

Graphite has a low potential substantially equal to that of a lithium metal (higher than or equal to 0.05 V and lower than or equal to 0.3 V vs. Li/Li⁺) when lithium ions are inserted into graphite (while a lithium-graphite intercalation compound is formed). For this reason, a lithium-ion battery using graphite can show a high operating voltage. In addition, graphite is preferred because of its advantages such as a relatively high capacity per unit volume, relatively small volume expansion, low cost, and a higher level of safety than that of a lithium metal.

As the negative electrode active material, an oxide such as titanium dioxide (TiO₂), lithium titanium oxide (Li₄Ti₅O₁₂), a lithium-graphite intercalation compound (LiₓC₆), niobium pentoxide (Nb₂O₅), tungsten dioxide (WO₂), or molybdenum dioxide (MoO₂) can be used.

Alternatively, as the negative electrode active material, Li₃₋ₓMₓN (M is Co, Ni, or Cu) with a Li₃N structure, which is a nitride of lithium and a transition metal, can be used. For example, Li_{2.6}Co_{0.4}N is preferable because of its high discharge capacity (900 mAh/g per active material weight and 1890 mAh/cm³) .

A nitride containing lithium and a transition metal is preferably used, in which case lithium ions are contained in the negative electrode active material and thus the negative electrode active material can be used in combination with a material for a positive electrode active material that does not contain lithium ions, such as V₂O₅ described above or Cr₃O₈. Note that even in the case of using a material containing lithium ions as a positive electrode active material, the nitride containing lithium and a transition metal can be used as the negative electrode active material by extracting lithium ions contained in the positive electrode active material in advance.

A material that causes a conversion reaction can be used for the negative electrode active material. For example, a transition metal oxide that does not form an alloy with lithium, such as cobalt oxide (CoO), nickel oxide (NiO), or iron oxide (FeO), may be used as the negative electrode active material. Other examples of the material that causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃.

For the conductive material and the binder that can be included in the negative electrode active material layer, materials similar to those for the conductive material and the binder that can be included in the positive electrode active material layer can be used.

As another form of the negative electrode of the present invention, a negative electrode that does not contain a negative electrode active material can be used. In a battery cell including the negative electrode that does not contain a negative electrode active material, lithium can be deposited on a negative electrode current collector at the time of charging, and lithium on the negative electrode current collector can be dissolved at the time of discharging. Thus, lithium is on the negative electrode current collector in the states except for the completely discharged state.

In the case where the negative electrode that does not contain a negative electrode active material is used, a film for making lithium deposition uniform may be provided over the negative electrode current collector. For the film for making lithium deposition uniform, for example, a solid electrolyte having lithium ion conductivity can be used. As the solid electrolyte, a sulfide-based solid electrolyte, an oxide-based solid electrolyte, or a polymer-based solid electrolyte can be used, for example. Among them, a film of the polymer-based solid electrolyte can be uniformly formed over the negative electrode current collector relatively easily, and thus is suitable as the film for making lithium deposition uniform.

In the case where the negative electrode that does not contain a negative electrode active material is used, a negative electrode current collector having unevenness can be used. In the case where the negative electrode current collector having unevenness is used, a depression of the negative electrode current collector becomes a cavity in which lithium contained in the negative electrode current collector is easily deposited, so that the lithium can be prevented from having a dendrite-like shape when being deposited.

### Conductive Additive

The negative electrode contains a conductive additive. As the conductive additive contained in the negative electrode, the conductive additive contained in the positive electrode can be used.

### Separator

The battery cell includes a separator positioned between the positive electrode and the negative electrode. The separator insulates the positive electrode and the negative electrode from each other. It is preferable that the separator have stability with respect to an electrolyte and be formed using a material with an excellent liquid-retaining property. As the separator, a separator formed using, for example, a fiber containing cellulose, such as paper, nonwoven fabric, glass fiber, ceramics, or synthetic fiber containing nylon (polyamide), vinylon (polyvinyl alcohol-based fiber), polyester, polyimide, acrylic, polyolefin, or polyurethane can be used.

The separator preferably has a porosity higher than or equal to 30% and lower than or equal to 85%, further preferably higher than or equal to 45% and lower than or equal to 65%. High porosity is preferred because it facilitates impregnation with an electrolyte. The porosity of the separator on the positive electrode side may be different from that on the negative electrode side, and the porosity on the positive electrode side is preferably higher than the porosity on the negative electrode side. Examples of a structure with different porosities are a single material having different porosities and different kinds of materials with different porosities. In the case where different kinds of materials are used, stacking these materials allows the separator to have different porosities.

The thickness of the separator is preferably greater than or equal to 5 μm and less than or equal to 200 μm, further preferably greater than or equal to 5 μm and less than or equal to 100 μm.

The separator preferably has an average pore size greater than or equal to 40 nm and less than or equal to 3 μm, further preferably greater than or equal to 70 nm and less than or equal to 1 μm. A large average pore size is preferred because it facilitates passage of carrier ions. The average pore size of the separator on the positive electrode side may be different from that on the negative electrode side, and the average pore size on the positive electrode side is preferably larger than the average pore size on the negative electrode side. Examples of a structure with different average pore sizes are a single material having different average pore sizes and different kinds of materials with different average pore sizes. In the case where different kinds of materials are used, stacking these materials allows the separator to have different average pore sizes.

The separator preferably has a heat resistance temperature higher than or equal to 200° C.

A separator including a polyimide and having a thickness greater than or equal to 10 μm and less than or equal to 50 μm and a porosity higher than or equal to 75% and lower than or equal to 85% is preferably used to increase the output characteristics of the battery cell.

The separator may be processed into a bag-like shape to enclose or sandwich any one of the positive electrode and the negative electrode.

The total thickness of the separator is preferably greater than or equal to 1 μm and less than or equal to 100 μm, and as long as having a thickness in this range, the separator may have either a single-layer structure or a multilayer structure. As the separator having a multilayer structure, an organic material film of polypropylene, polyethylene, or the like coated with a ceramic-based material, a fluorine-based material, a polyamide-based material, a mixture thereof, or the like can be used. As the ceramic-based material, aluminum oxide particles or silicon oxide particles can be used, for example. As the fluorine-based material, PVDF or polytetrafluoroethylene can be used, for example. As the polyamide-based material, nylon or aramid (meta-based aramid or para-based aramid) can be used, for example.

When the surface of the separator is coated with the ceramic-based material, the oxidation resistance is improved; hence, deterioration of the separator in high-voltage charging and discharging can be suppressed and accordingly, the reliability of the battery cell can be improved. When the surface of the separator is coated with the fluorine-based material, the separator is easily brought into close contact with an electrode, resulting in high output characteristics. When the surface of the separator is coated with the polyamide-based material, in particular, aramid, heat resistance is improved; hence, the safety of the battery cell can be improved.

For example, both surfaces of a polypropylene film may be coated with a mixed material of aluminum oxide and aramid. Alternatively, a surface of a polypropylene film that is in contact with the positive electrode may be coated with a mixed material of aluminum oxide and aramid, and a surface of the polypropylene film that is in contact with the negative electrode may be coated with the fluorine-based material.

With the use of such a separator having a multilayer structure, which can have the functions of the materials, insulation between the positive electrode and the negative electrode can be ensured and the safety of the battery cell can be kept even when the total thickness of the separator is small. This is preferable because in that case, the capacity of the battery cell per volume can be increased.

### Exterior Body

The battery cell includes an exterior body. For the exterior body, a metal material such as aluminum or a resin material can be used, for example. A film-like exterior body can also be used. As the film, for example, it is possible to use a film having a three-layer structure in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided over the metal thin film as the outer surface of the exterior body.

Although the structure and the like of the battery cell that can be used in the above embodiments have been described above as examples in this embodiment, the present invention is not construed as being limited to the above examples.

This embodiment can be used in appropriate combination with the other embodiments.

### Embodiment 3

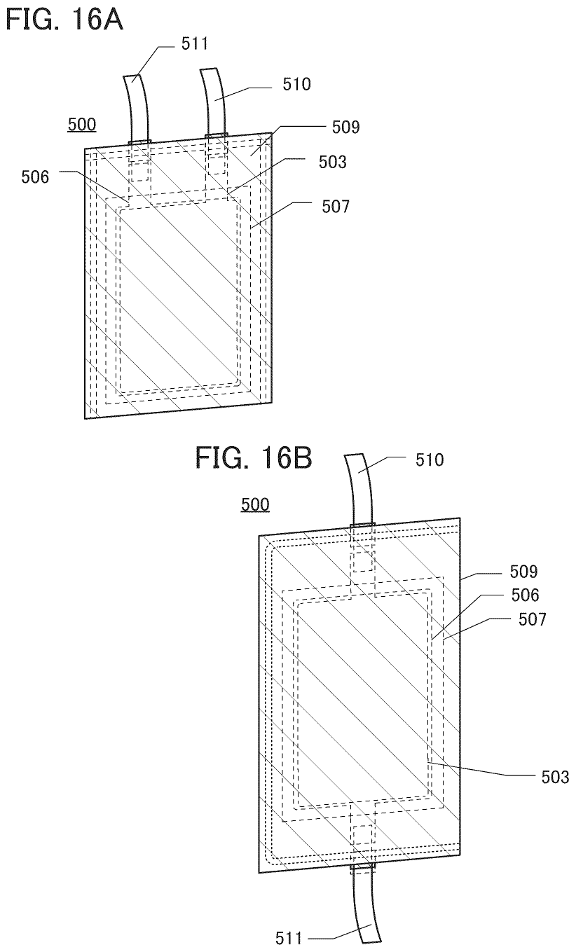

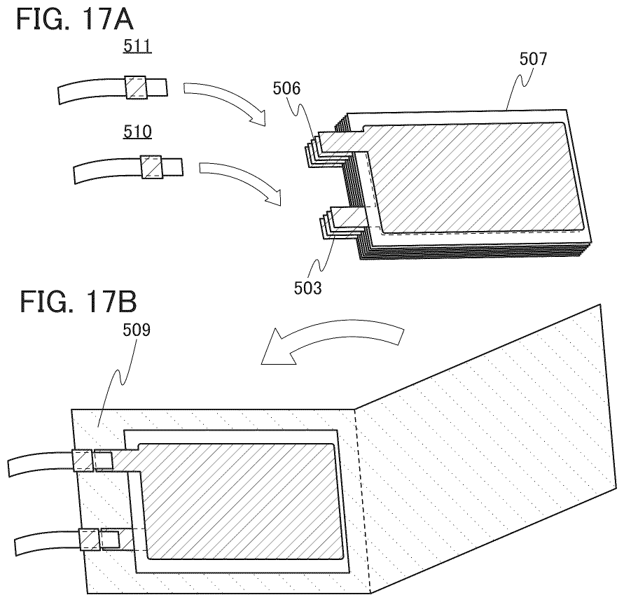

In this embodiment, other structure examples of a battery cell are described with reference to FIG. 16 and FIG. 17.

### Laminated Battery Cell

A secondary battery 500 illustrated in FIG. 16A and FIG. 16B is a laminated battery cell. In FIG. 16A and FIG. 16B, a positive electrode 503, a negative electrode 506, a separator 507, an exterior body 509, a positive electrode lead electrode 510, and a negative electrode lead electrode 511 are included.

FIG. 16A illustrates an external view of the positive electrode 503 and the negative electrode 506. Although not illustrated, the positive electrode 503 includes a positive electrode current collector, and a positive electrode active material layer is formed on the positive electrode current collector. A region where the positive electrode current collector is exposed from the positive electrode active material layer is referred to as a tab region. The tab region is electrically connected to the positive electrode lead electrode 510. Although not illustrated, the negative electrode 506 includes a negative electrode current collector, and a negative electrode active material layer is formed on the negative electrode current collector. A region where the negative electrode current collector is exposed from the negative electrode active material layer is a tab region, and the tab region is electrically connected to the negative electrode lead electrode 511.

### Method for Manufacturing Laminated Battery Cell

An example of a method for manufacturing the laminated battery cell whose external view is illustrated in FIG. 16A is described with reference to FIG. 17A and FIG. 17B.

First, the negative electrodes 506 and the positive electrodes 503 are stacked as illustrated in FIG. 17A. The separator 507 is placed between the negative electrode 506 and the positive electrode 503. Here, an example in which five negative electrodes and four positive electrodes are used is shown. Next, the tab regions of the positive electrodes 503 are bonded to each other, and the positive electrode lead electrode 510 is bonded to the tab region of the positive electrode on the outermost surface. The bonding is performed by ultrasonic welding, for example. In a similar manner, the tab regions of the negative electrodes 506 are bonded to each other, and the negative electrode lead electrode 511 is bonded to the tab region of the negative electrode on the outermost surface.

After that, as shown in FIG. 17B, the negative electrodes 506, the separators 507, and the positive electrodes 503 are placed over the exterior body 509.

Subsequently, the exterior body 509 is folded along a portion shown by a dashed line, as illustrated in FIG. 17B. Then, the outer edges of the exterior body 509 are bonded to each other. The bonding can be performed by thermocompression, for example. At this time, an unbonded region (hereinafter, referred to as an inlet) is provided for part (or one side) of the exterior body 509 so that an electrolyte solution (not illustrated) can be introduced later.

Next, the electrolyte solution is introduced into the exterior body 509 from the inlet of the exterior body 509. The electrolyte solution is preferably introduced in a reduced pressure atmosphere or in an inert atmosphere. Lastly, the inlet is sealed by bonding. In this manner, a laminated battery cell can be fabricated.

This embodiment can be used in appropriate combination with the other embodiments.

### Embodiment 4

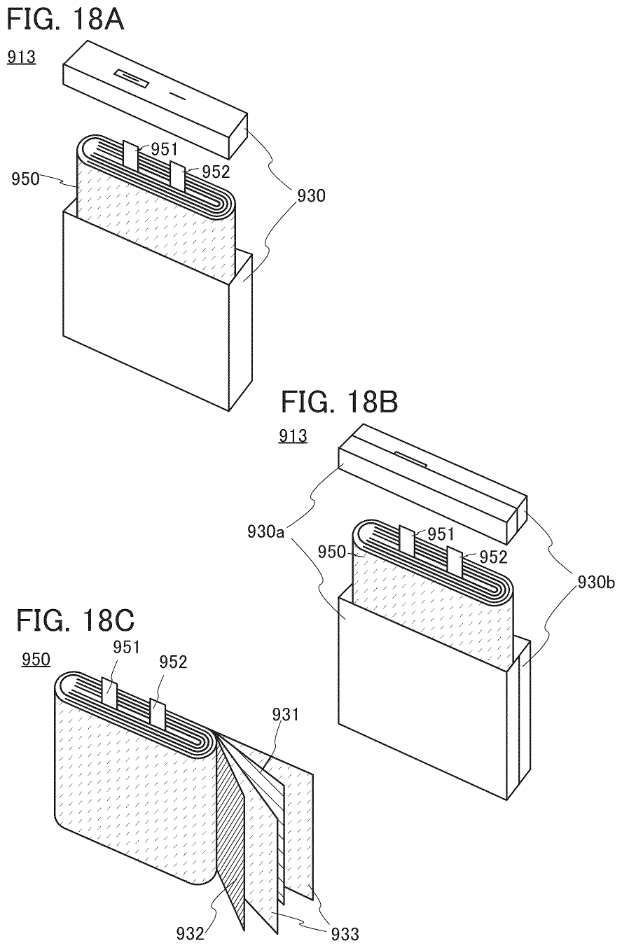

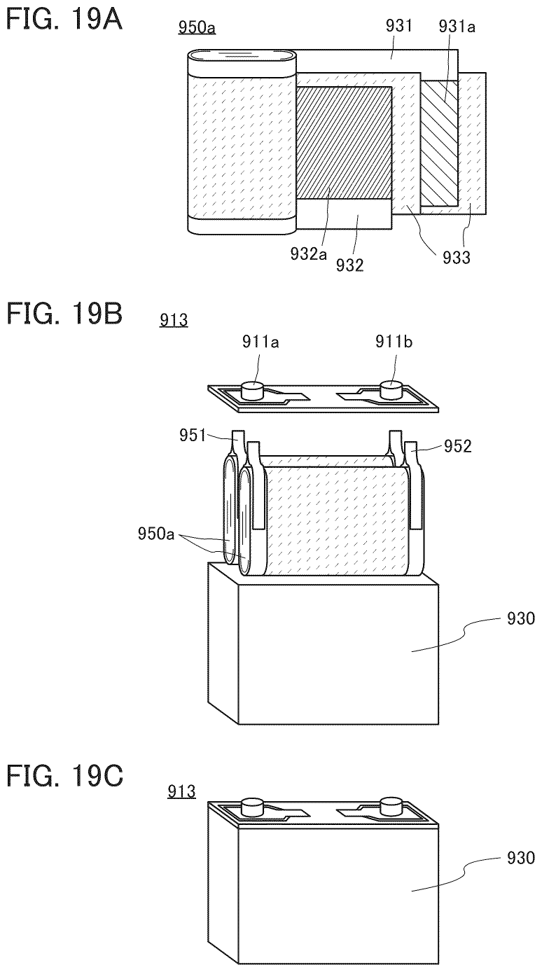

In this embodiment, other structure examples of the battery cell are described with reference to FIG. 18 and FIG. 19.

### Rectangular Battery Cell

A secondary battery 913 illustrated in FIG. 18A is a rectangular battery cell and includes a wound body 950 provided with a terminal 951 and a terminal 952 inside a housing 930. The wound body 950 is soaked in an electrolyte solution inside the housing 930. The terminal 952 is in contact with the housing 930. The terminal 951 is not in contact with the housing 930 with the use of an insulator or the like. In FIG. 18A, the housing 930 divided into pieces is shown for convenience; however, in the actual structure, the wound body 950 is covered with the housing 930 and the terminal 951 and the terminal 952 extend to the outside of the housing 930. For the housing 930, a metal material (e.g., aluminum) or a stack of the metal material and a resin material (also referred to as an organic resin) can be used.

As illustrated in FIG. 18B, the housing 930 illustrated in FIG. 18A may be formed using a plurality of materials. For example, in the secondary battery 913 illustrated in FIG. 18B, a housing 930a and a housing 930b are bonded to each other, and the wound body 950 is provided in a region surrounded by the housing 930a and the housing 930b.

For the housing 930a, a metal material or a stack of the metal material and a resin material can be used, for example. In particular, when a material such as an organic resin is used for the side on which an antenna is formed, blocking of an electric field by the secondary battery 913 can be inhibited. When an electric field is not significantly blocked by the housing 930a, an antenna may be provided inside the housing 930a. For the housing 930b, a metal material or a stack of the metal material and a resin material can be used, for example.

FIG. 18C illustrates a structure of the wound body 950. The wound body 950 includes a negative electrode 931, a positive electrode 932, and separators 933. The wound body 950 is obtained by winding a sheet of a stack in which the negative electrode 931 and the positive electrode 932 overlap with the separator 933 therebetween. Note that a plurality of stacks each including the negative electrode 931, the positive electrode 932, and the separators 933 may be further stacked.

As illustrated in FIG. 19A to FIG. 19C, the secondary battery 913 being the rectangular battery cell may include a wound body 950a. The wound body 950a illustrated in FIG. 19A includes the negative electrode 931, the positive electrode 932, and the separators 933. The negative electrode 931 includes a negative electrode active material layer 931a. The positive electrode 932 includes a positive electrode active material layer 932a.

The separator 933 has a larger width than the negative electrode active material layer 931a and the positive electrode active material layer 932a, and is wound to overlap with the negative electrode active material layer 931a and the positive electrode active material layer 932a. In terms of safety, the width of the negative electrode active material layer 931a is preferably larger than that of the positive electrode active material layer 932a. The wound body 950a having such a shape is preferable because of its high degree of safety and high productivity.

As illustrated in FIG. 19B, the negative electrode 931 is electrically connected to the terminal 951. The terminal 951 is electrically connected to a terminal 911a. The positive electrode 932 is electrically connected to the terminal 952. The terminal 952 is electrically connected to a terminal 911b.

As illustrated in FIG. 19C, the wound body 950a and an electrolyte solution are covered with the housing 930, whereby the secondary battery 913 is obtained. The housing 930 is preferably provided with a safety valve, an overcurrent protection element, and the like. A safety valve is a valve to be released by a predetermined internal pressure of the housing 930 in order to prevent the battery from exploding.

As illustrated in FIG. 19B, the secondary battery 913 may include a plurality of wound bodies 950a. The use of the plurality of wound bodies 950a enables the secondary battery 913 to have higher discharge capacity. The description of the secondary battery 913 illustrated in FIG. 18A to FIG. 18C can be referred to for the other components of the secondary battery 913 illustrated in FIG. 19A and FIG. 19B.

### Embodiment 5

In this embodiment, examples of a vehicle or the like provided with the battery pack that is one embodiment of the present invention or the like are described.

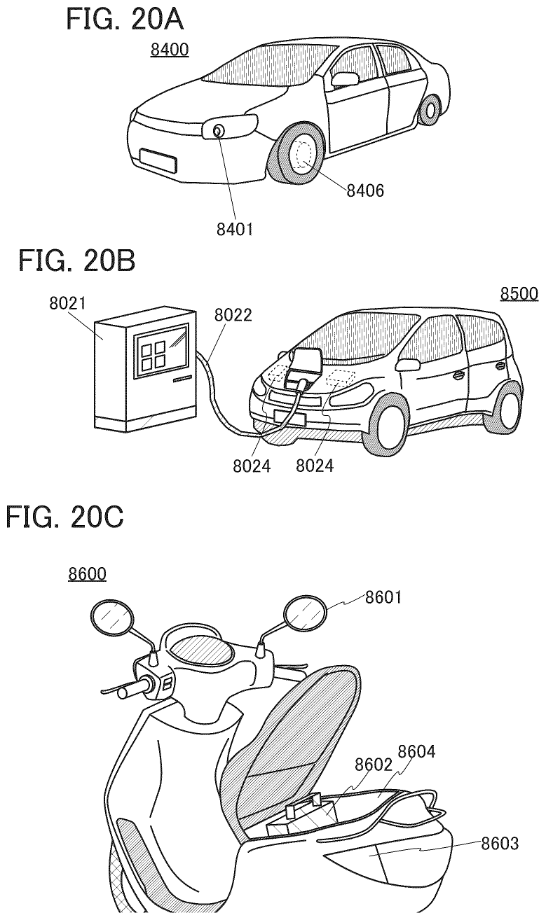

An automobile 8400 illustrated in FIG. 20A is an electric vehicle that moves on the power of an electric motor. Alternatively, the automobile 8400 is a hybrid vehicle capable of moving appropriately using either an electric motor or an engine as a power source.

The automobile 8400 is also provided with the battery pack of one embodiment of the present invention or the like. Electric power from the battery pack can be used not only for driving an electric motor 8406, but also for supplying electric power to a light-emitting device such as a headlight 8401 or a room light (not illustrated). Electric power from the battery pack can also be supplied to a display device included in the automobile 8400, such as a speedometer or a tachometer. Electric power from the battery pack can also be supplied to a semiconductor device included in the automobile 8400, such as a navigation system or a multi-purpose display.

An automobile 8500 illustrated in FIG. 20B can be charged when a battery pack included in the automobile 8500 is supplied with power from external charging equipment by a plug-in system, a contactless power feeding system, or the like. FIG. 20B illustrates a state where a battery pack 8024 provided in the automobile 8500 is charged from a ground installation type charging apparatus 8021 through a cable 8022. The charging apparatus 8021 may be a charging station provided in a commerce facility or a power source in a house. For example, with the use of a plug-in technique, the battery pack 8024 provided in the automobile 8500 can be charged by being supplied with power from outside. The charging can be performed by converting AC power into DC power through a converter such as an ACDC converter.

Although not illustrated, the vehicle may be provided with a power receiving device so that it can be charged by being supplied with power from an above-ground power transmitting device in a contactless manner. In the case of the contactless power feeding system, by fitting a power transmitting device in a road or an exterior wall, charging can be performed not only when the vehicle is stopped but also when moving. In addition, the contactless power feeding system may be utilized to perform transmission and reception of power between vehicles. Furthermore, a solar cell may be provided in the exterior of the vehicle to charge the secondary battery when the vehicle is stopping or moving. To supply power in such a contactless manner, an electromagnetic induction method or a magnetic resonance method can be used.

In addition, FIG. 20C is an example of a motorcycle using a battery pack of one embodiment of the present invention. A motor scooter 8600 illustrated in FIG. 20C includes a battery pack 8602, side mirrors 8601, and direction indicators 8603. The battery pack 8602 can supply electricity to the direction indicators 8603.

Furthermore, in the motor scooter 8600 illustrated in FIG. 20C, the battery pack 8602 can be stored in an under-seat storage 8604. The battery pack 8602 can be stored in the under-seat storage 8604 even when the under-seat storage 8604 is small. The battery pack 8602 is detachable; thus, the battery pack 8602 is carried indoors when charged, and is stored before the motor scooter is driven.

When the above-described vehicle is provided with the battery pack of one embodiment of the present invention, the battery can be efficiently used and a next-generation clean energy vehicle can be achieved.

This embodiment can be used in appropriate combination with the other embodiments.

### Embodiment 6

In this embodiment, examples of a building or the like provided with the battery pack that is one embodiment of the present invention or the like are described.

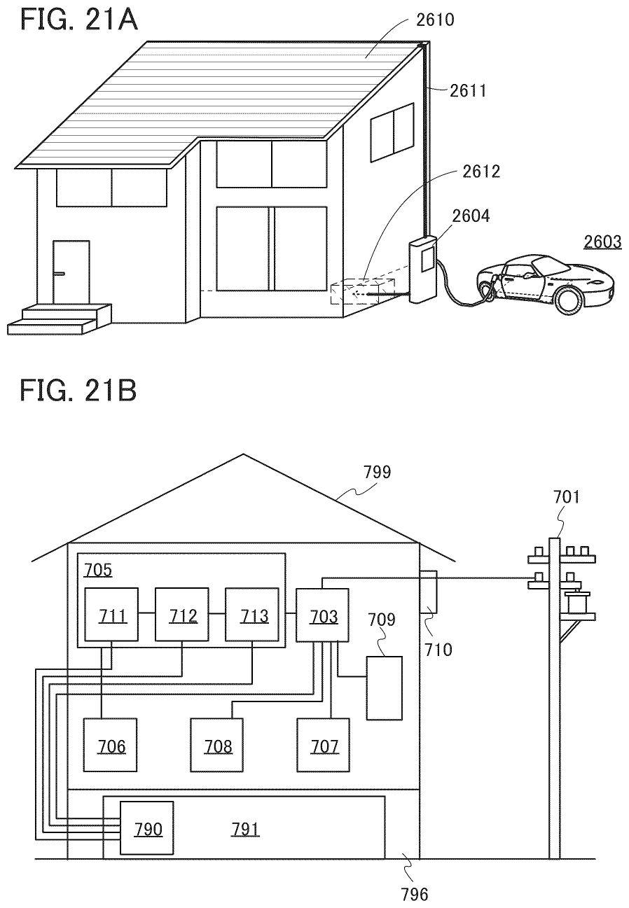

A house illustrated in FIG. 21A includes a power storage device 2612 including a battery pack and a solar panel 2610. The power storage device 2612 can be provided in an underfloor space. The power storage device 2612 is electrically connected to the solar panel 2610 through a wiring 2611 or the like. The power storage device 2612 can be charged with electric power generated by the solar panel 2610, and the charged electric power can be used as driving power of a household appliance in the house. Since the power storage device 2612 includes the battery pack of one embodiment of the present invention, the overcooling state can be prevented. Thus, the output characteristics of the battery cell included in the battery pack are not lowered, which is preferable.

The house may be provided with a ground-based power storage device 2604. The ground-based power storage device 2604 is electrically connected to the power storage device 2612 and the solar panel 2610 through a wiring or the like. Since the ground-based power storage device 2604 is provided with the battery pack of one embodiment of the present invention, the overcooling state can be prevented. Thus, the output characteristics of the battery cell included in the battery pack are not lowered, which is preferable.

Electric power stored in the ground-based power storage device 2604 can be used as driving power of the vehicle 2603. For that purpose, the ground-based power storage device 2604 can be electrically connected to the charging port of the vehicle 2603.

FIG. 21B illustrates an example of a power storage device provided in an underfloor space. As illustrated in FIG. 21B, a power storage device 791 is provided in an underfloor space 796 of a building 799.

The power storage device 791 is provided with a control device 790, and the control device 790 is electrically connected to a distribution board 703, a power storage controller 705 (also referred to as a control device), an indicator 706, and a router 709 through wirings.

Electric power is transmitted from a commercial power source 701 to the distribution board 703 through a service wire mounting portion 710. Moreover, electric power is transmitted to the distribution board 703 from the power storage device 791 and the commercial power source 701, and the distribution board 703 supplies the transmitted electric power to a general load 707 and a power storage load 708 through outlets (not illustrated).

The general load 707 is, for example, an electronic device such as a TV or a personal computer. The power storage load 708 is, for example, an electronic device such as a microwave, a refrigerator, or an air conditioner.

The power storage controller 705 includes a measuring portion 711, a predicting portion 712, and a planning portion 713. The measuring portion 711 has a function of measuring the amount of electric power consumed by the general load 707 and the power storage load 708 during a day (e.g., from midnight to midnight). The measuring portion 711 may have a function of measuring the amount of electric power of the power storage device 791 and the amount of electric power supplied from the commercial power source 701. The predicting portion 712 has a function of predicting, on the basis of the amount of electric power consumed by the general load 707 and the power storage load 708 during a given day, the demand for electric power consumed by the general load 707 and the power storage load 708 during the next day. The planning portion 713 has a function of making a charge and discharge plan of the power storage device 791 on the basis of the demand for electric power predicted by the predicting portion 712.

The amount of electric power consumed by the general load 707 and the power storage load 708 and measured by the measuring portion 711 can be checked with the indicator 706. An electronic device such as a TV or a personal computer can also show it through the router 709. Furthermore, it can be checked with a portable electronic terminal such as a smartphone or a tablet through the router 709. The indicator 706, the electronic device, the portable electronic terminal, or the like can also show, for example, the demand for electric power depending on a time period (or per hour) that is predicted by the predicting portion 712.

### REFERENCE NUMERALS

10: battery pack, 11a: first battery module, 11b: second battery module, 11: battery module, 14a: protruding portion, 14: heat dissipation mechanism, 15a: first switching mechanism, 15b: second switching mechanism, 15: switching mechanism, 16: first housing, 17a: guide, 17: second housing, 18: cell block, 19: battery cell, 20a: first portion, 20b: second portion, 20c: upper portion, 20d: lower portion, 20: case, 21: switch, 22: heater, 23: bimetal member, 24: pin, 26a: first contact, 26b: second contact, 30: third housing, 32a: first heat transfer plate, 32b: second heat transfer plate, 32c: projection, 32: heat transfer plate, 39: battery cell, 100: vehicle, 109a: charging port for normal charging, 109b: charging port for rapid charging, 109: charging port

1. A battery pack comprising a plurality of battery cells, a heat dissipation mechanism, and a switching mechanism,
wherein the switching mechanism is configured to move the heat dissipation mechanism in accordance with a temperature of the plurality of battery cells to switch a state where the battery cells are close to the heat dissipation mechanism and a state where the battery cells are separated from the heat dissipation mechanism.

2. The battery pack according to claim 1,
wherein the heat dissipation mechanism comprises a region not overlapping with the plurality of battery cells, and the switching mechanism is placed in the region in a top view.

3. The battery pack according to claim 1,
wherein the switching mechanism comprises a bimetal member.

4. The battery pack according to claim 1, comprising a housing comprising a heat-insulating member surrounding the plurality of battery cells.

5. The battery pack according to claim 1,
wherein the heat dissipation mechanism comprises a heat sink.

6. The battery pack according to claim 1,
wherein the heat dissipation mechanism comprises a heat sink utilizing natural cooling.

7. A vehicle equipped with the battery pack described in claim 1.

8. A battery pack comprising a plurality of battery cells, a heat dissipation mechanism, a switching mechanism, and a heat transfer plate,
wherein one end of the heat transfer plate comprises a first region in contact with the plurality of battery cells,
wherein the other end of the heat transfer plate comprises a second region overlapping with the heat dissipation mechanism, and
wherein the switching mechanism is configured to move the second region in accordance with a temperature of the plurality of battery cells to switch a state where the plurality of battery cells are close to the heat dissipation mechanism and a state where the plurality of battery cells are separated from the heat dissipation mechanism.

9. The battery pack according to claim 8,
wherein the switching mechanism comprises a bimetal member.

10. The battery pack according to claim 8, comprising a housing comprising a heat-insulating member surrounding the plurality of battery cells.

11. The battery pack according to claim 8,
wherein the heat dissipation mechanism comprises a heat sink.

12. The battery pack according to claim 8,
wherein the heat dissipation mechanism comprises a heat sink utilizing natural cooling.

13. A vehicle equipped with the battery pack described in claim 8.
